(19) United States
(12) Patent Application Publication
(10) Pub. No.: US 2015/0296852 A1
(43) Pub. Date: Oct. 22, 2015

(54) COMPOSITIONS AND METHODS FOR IMPROVING STABILITY AND EXTENDING SHELF LIFE OF SENSITIVE FOOD ADDITIVES AND FOOD PRODUCTS THEREOF

(71) Applicant: SPAI Group Ltd., Grand Cayman (KY)

(72) Inventors: Adel PENHASI, Holon (IL); Israel RUBIN, Kfar Saba (IL); Albert REUVENI, Jerusalem (IL)

(73) Assignee: SPAI Group Ltd., Grand Cayman (KY)

(21) Appl. No.: 14/100,052

(22) Filed: Dec. 9, 2013

Related U.S. Application Data
(63) Continuation-in-part of application No. PCT/IB2012/052857, filed on Jun. 6, 2012.
(60) Provisional application No. 61/494,218, filed on Jun. 7, 2011.

(51) Int. Cl. A23L 1/30; A23L 1/00

(52) U.S. Cl. CPC A23L 1/3008; A23L 1/0023; A23L 1/0029; A23V 2002/00

(57) ABSTRACT

A composition comprising a core comprising at least one oxygen-sensitive liquid natural pharmaceutically or nutritionally active agent absorbed or adsorbed onto an absorbent, an intermediate layer, comprising an interfacial tension adjusting polymer, wherein said interfacial tension adjusting polymer is characterized by an aqueous solution of 0.1% having a surface tension lower than 60 mN/m when measured at 25 C, and
at least one barrier coating layer comprising a polymer having oxygen transmission rate of less than 1000 cc/m²/24 hr measured at standard test conditions and a water vapor transmission rate of less than 400 g/m²/day.

### FIELD OF THE INVENTION

The present invention generally relates to food additives and food products, and more particularly to novel compositions and methods for improving stability and extending shelf life of sensitive food additives and food products thereof.

### BACKGROUND OF THE INVENTION

Food additives may come in a variety of forms, including solids and liquids. Although possibly possessing some health benefits, many food additives such as fatty acids, may be sensitive to environmental conditions, such as temperature, oxidation and the like.

Omega-3, omega-6 and Allicin are examples of substances which may be sensitive to oxidation.

Omega-3 and omega-6 are essential fatty acids (EFAs) because they are not produced by the body and must be obtained through diet or supplementation. These EFAs are necessary for skin and hair growth, cholesterol metabolism and reproductive performance. Omega-3 fatty acids are important for proper neural, visual and reproductive functions while omega-6 fatty acids are critical for proper tissue development during gestation and infancy.

Omega-3 (n-3) fatty acids are derived from two main dietary sources: marine, and nut and plant oils. The primary marine-derived omega-3 fatty acids with 20 or more carbon atoms are eicosapentaenoic acid (EPA; C20:5n-3) and docosahexaenoic acid (DHA; C22:6n-3) present in high concentrations in deep water oily fish such as tuna, salmon, mackerel and herring as well as seal oil, krill and marine algae.

Alliin is a sulfoxide that is a natural constituent of fresh garlic and it is a derivative of the amino acid cysteine. Allicin is an organosulfur compound obtained from garlic. Allicin is not present in garlic unless tissue damage occurs and is formed by the action of the enzyme alliinase on alliin. This compound exhibits antibacterial and anti-fungal properties.

Most naturally-produced fatty acids (created or transformed in animal or plant cells with an even number of carbon in chains) are in cis-configuration where they are more easily transformable. The trans-configuration results in much more stable chains that are very difficult to further break or transform, forming longer chains that aggregate in tissues and lack the necessary hydrophilic properties. This trans-configuration can be the result of the transformation in alkaline solutions, or of the action of some bacteria that are shortening the carbonic chains. Natural transforms in plant or animal cells more rarely affect the last n-3 group itself. However, n-3 compounds are still more fragile than n-6 because the last double bond is geometrically and electrically more exposed, notably in the natural cis-configuration. Like free oxygen radicals, iodine can add to double bonds of docosahexaenoic acid and arachidonic acid forming iodolipids.

The oxidation process of such oxygen-sensitive agents causes a decline in their functionality and consequently deficiency in health efficiency and medical benefits. In some cases, the oxidation process of such oxidizable agents will be accompanied with unpleasant taste and pungent odor.

The oxidation process is a kinetic process which can be enhanced by increasing temperature, the stability of such oxygen sensitive liquid agents may be enhanced at either ambient temperature or higher temperature which will eventually shorten the shelf life of such oxygen sensitive liquid agents. Additionally, the latter fact may prevent such oxygen sensitive liquid agents to be added to such functional foods that undergo heating process during handling and preparation process.

Thus attempts to perform encapsulation of liquid heat sensitive components, for example, liquid nutraceutical components into matrixes that are edible, have been made in the past and are generally considered difficult.

Some attempts at encapsulation are described in the following patent documents: U.S. Pat. No. 7,344,747 (Perlman), U.S. Pat. No. 4,895,725 (Kantor), US20050233002 (Trubiano), U.S. Pat. No. 6,234,464 (Krumbholz), U.S. Pat. No. 6,500,463 (van Lengerich), US20040017017 (van Lengerich), U.S. Pat. No. 6,723,358 (van Lengerich), US20070098854 (van Lengerich), U.S. Pat. No. 7,727,629 (Yan), US20060115553 (Gautam), US20050233044 (Rader), US20060134180 (Yan), U.S. Pat. No. 6,428,461 (Marquez), U.S. Pat. No. 4,895,725, WO92/00130, U.S. Pat. No. 5,183,690 (Carr), U.S. Pat. No. 5,567,730 (Miyashita), WO95/26752, and U.S. Pat. No. 5,106,639 (Lee).

Products implementing such previous efforts require careful handling and excess heat, moisture, and high shear forces must be avoided, and possess many drawbacks.

First, conventional encapsulation processes expose matrix material and encapsulants to high temperatures, causing thermal destruction or loss of encapsulant. Thus, either large overdoses of encapsulant would be required (which would turn out to be very expensive), or the encapsulant would not sustain the encapsulation process at all.

Second, if the encapsulant can be encapsulated into a matrix under sufficiently low temperatures and the resulting product may be a soft solid, the softness of the microencapsules shell, however, disappears under either relatively high temperature of cooking or even the temperature at which the particles are consumed or the eating temperature resulting in microencapsules shell either to be removed or be oxygen permeable. As a result, a sensitive encapsulant may be either exposed to heat and oxygen or released either in the food or in the mouth when the particles or the food containing microencapsules are consumed leaving unpleasant odor and taste. Previous products of this kind exhibit only a partial protection against both oxidation and temperature and are limited to storage taking place only at low temperature.

Third, liquid nutraceutical components encapsulated as a liquid entrapped in a solid dense shell may cause problems when the resulting microcapsules are chewed as they may be broken, releasing liquid nutraceutical components in the mouth during chewing. Furthermore they cannot also be used as dense pellets for a variety of processing applications, since such microcapsulating shells mostly are not able to withstand the shear forces exerted during handling and processing of foodstuff such as kneading and etc.

Consequently, they may eventually be broken to release the liquid nutraceutical components in the food. They can therefore be only swallowed as microcapsules or capsules without chewing.

### SUMMARY OF THE INVENTION

The present invention, in at least some embodiments, is of new compositions and methods for improving stability and extending shelf life of sensitive food additives and food products thereof.

According to some demonstrative embodiments of the present invention there is provided a composition that may be used as a supplement and/or food additive, for example, to be added into a food product.

In some demonstrative embodiments, the composition may comprise a core having at least one oxygen-sensitive liquid natural pharmaceutically or nutritionally active agent absorbed or adsorbed onto a substrate and at least one coating layer designed to stabilize the oxygen-sensitive liquid natural pharmaceutically or nutritionally active agent.

According to some embodiments, the composition may include a core having at least one oxygen-sensitive liquid natural pharmaceutically or nutritionally active agent, optionally further comprising at least one excipient, and a plurality of coating layers, including, for example, a fatty coating layer, an intermediate coating layer, an outer coating layer and optionally an enteric coating layer.

According to some demonstrative embodiments of the present invention there is provided a composition comprising a core comprising at least one oxygen-sensitive liquid natural pharmaceutically or nutritionally active agent absorbed or adsorbed onto an absorbent; an intermediate layer, comprising an interfacial tension adjusting polymer, wherein said interfacial tension adjusting polymer is characterized by an aqueous solution of 0.1% having a surface tension lower than 60 mN/m when measured at 25 C; and at least one barrier coating layer comprising a polymer having oxygen transmission rate of less than 1000 cc/m²/24 hr measured at standard test conditions and a water vapor transmission rate of less than 400 g/m²/day.

According to some embodiments, the barrier coating layer may comprise one or more of polyvinyl alcohol (PVA), Povidone (PVP: polyvinyl pyrrolidone), Copovidone (copolymer of vinyl pyrrolidone and vinyl acetate), Kollicoat Protect (BASF) which is a mixture of Kollicoat IR (a polyvinyl alcohol (PVA)-polyethylene glycol (PEG) graft copolymer) and polyvinyl alcohol (PVA), Opadry AMB (Colorcon) which is a mixture based on PVA, Aquarius MG which is a cellulosic-based polymer containing natural wax, lecithin, xanthan gum, gelatin, starch and talc, low molecular weight HPC (hydroxypropyl cellulose), low molecular weight carboxy methyl cellulose such as 7LF, 7L2P, Na-carboxy methyl cellulose.

According to some embodiments, the barrier coating layer may comprise one or more of Na-carboxy methyl cellulose (CMC), gelatin or starch, or a combination thereof.

According to some embodiments, the core may further comprise a fatty acid.

According to some embodiments, the composition may further comprise an intermediate coating layer.

According to some embodiments, the composition may further comprise an enteric coating layer.

According to some embodiments, the absorbent may comprise one or more of MCC (microcrystalline cellulose), silicon dioxide, lactose, talc, aluminum silicate, dibasic calcium phosphate anhydrous, starch or a starch derivative, a polysaccharide or a combination thereof.

According to some embodiments, the starch derivative may comprise one or more of partially pregelatinized starch, pregelatinized starch, starch phosphate, modified food starch or a combination thereof.

According to some embodiments, the polysaccharide may comprise one or more of glucose-based polysaccharides, cellulose, mannose-based polysaccharides (mannan), galactose-based polysaccharides (galactan), N-acetylglucosamine-based polysaccharides including chitin, gums such as arabic gum (gum acacia), modified polysaccharides such as crosslinked pectin, cross linked sodium alginate; cellulose derivatives such as ethyl cellulose, propyl cellulose, cross-linked cellulose derivatives and a combination thereof.

According to some embodiments, the polysaccharide may comprise one or more of glucan, glycogen, amylose, amylopectin,

According to some demonstrative embodiments of the present invention there is provided a composition comprising a core comprising at least one oxygen-sensitive liquid natural pharmaceutically or nutritionally active agent absorbed or adsorbed onto an absorbent, with the proviso that said liquid is not in the form of an emulsion; at least one intermediate coating layer comprising an interfacial tension adjusting polymer; and at least one barrier coating layer comprising polymer having oxygen transmission rate of less than 1000 cc/m²/24 hr measured at standard test conditions and a water vapor transmission rate of less than 400 g/m²/day.

According to some embodiments, the composition may further comprise a fatty coating layer comprising at least one hydrophobic solid fat or fatty acid having a melting point lower than 70° C. and higher than 25° C.

According to some embodiments, the fatty coating layer may be positioned directly on the core.

According to some embodiments, the said fatty coating layer may be positioned between the core and said intermediate layer.

According to some embodiments, the intermediate layer may comprises an aqueous solution of 0.1% having a surface tension lower than 60 mN/m measured at 25° C.

According to some embodiments, the surface tension may be lower than 50 mN/m.

According to some embodiments, the surface tension may be lower than 45 mN/m.

According to some demonstrative embodiments of the present invention there is provided a composition comprising a core comprising at least one oxygen-sensitive liquid natural pharmaceutically or nutritionally active agent; a fatty coating layer comprising least one hydrophobic solid fat or fatty acid having a melting point lower than 70° C. and higher than 25° C.; an intermediate coating layer positioned on said fatty coating layer; at least one barrier coating layer comprising a polymer having oxygen transmission rate of less than 1000 cc/m²/24 hr measured at standard test conditions and a water vapor transmission rate of less than 400 g/m²/day positioned on said intermediate layer; and at least one delayed release layer comprising an enteric polymer.

According to some embodiments, the intermediate layer may comprise a polymer whose an aqueous solution of 0.1% having a surface tension lower than 60 mN/m measured at 25° C.

According to some embodiments, the intermediate layer may comprise a water soluble polymer.

According to some embodiments, the intermediate layer may comprise a polymer selected from the group including hydroxypropylethylcellulose (HPEC), hydroxypropylcellulose (HPC), methylcellulose, ethylcellulose, pH-sensitive polymers, enteric polymers and/or a combination or combinations thereof.

According to some embodiments, the enteric polymer may comprise one or more of phthalate derivatives such as acid phthalate of carbohydrates, amylose acetate phthalate, cellulose acetate phthalate (CAP), other cellulose ester phthalates, cellulose ether phthalates, hydroxypropylcellulose phthalate (HPCP), hydroxypropylethylcellulose phthalate (HPECP), hydroxyproplymethylcellulose phthalate (HPMCP), hydroxyproplymethylcellulose acetate succinate (HPMCAS), methylcellulose phthalate (MCP), polyvinyl acetate phthalate (PVAcP), polyvinyl acetate hydrogen phthalate, sodium CAP, starch acid phthalate, cellulose acetate trimellitate (CAT), styrene-maleic acid dibutyl phthalate copolymer, styrene-maleic acid/polyvinylacetate phthalate copolymer, styrene and maleic acid copolymers, polyacrylic acid derivatives such as acrylic acid and acrylic ester copolymers, polymethacrylic acid and esters thereof, polyacrylic and methacrylic acid copolymers, and vinyl acetate and crotonic acid copolymers. In some embodiments, pH-sensitive polymers include shellac, phthalate derivatives, CAT, HPMCAS, polyacrylic acid derivatives, particularly copolymers comprising acrylic acid and at least one acrylic acid ester, Eudragit™ S (poly(methacrylic acid, methyl methacrylate)1:2); Eudragit L100™ (poly(methacrylic acid, methyl methacrylate)1:1); Eudragit L30D™, (poly(methacrylic acid, ethyl acrylate)1:1); and (Eudragit L100-55) (poly(methacrylic acid, ethyl acrylate)1:1) (Eudragit™ L is an anionic polymer synthesized from methacrylic acid and methacrylic acid methyl ester), polymethyl methacrylate blended with acrylic acid and acrylic ester copolymers, alginic acid and alginates, ammonia alginate, sodium, potassium, magnesium or calcium alginate, vinyl acetate copolymers, polyvinyl acetate 30D (30% dispersion in water), a poly(dimethylaminoethylacrylate) “Eudragit E™, a copolymer of methylmethacrylate and ethylacrylate with small portion of trimethylammonioethyl methacrylate chloride (Eudragit RL, Eudragit RS), a copolymer of methylmethacrylate and ethylacrylate (Eudragit NE 30D), Zein, shellac, gums, poloxamer, polysaccharides.

According to some embodiments, the melting point may be lower than 65° C. and higher than 30° C.

According to some embodiments, the melting point may be lower than 60° C. and higher than 35° C.

According to some embodiments, the fatty coating layer may comprise one or more of fats, fatty acids, fatty acid esters, fatty acid triesters, salts of fatty acids, fatty alcohols, phospholipids, solid lipids, waxes, lauric acid, stearic acid, alkenes, waxes, alcohol esters of fatty acids, long chain alcohols and glucoles, and combinations thereof.

According to some embodiments, the salt of fatty acids may comprise one or more of aluminum, sodium, potassium and magnesium salts of fatty acids.

According to some embodiments, the fatty coating layer may comprise one or more of paraffin wax composed of a chain of alkenes, normal paraffins of type CₙH₂ₙ₊₂; natural waxes, synthetic waxes, hydrogenated vegetable oil, hydrogenated castor oil; fatty acids, such as lauric acid, myristic acid, palmitic acid, palmitate, palmitoleate, hydroxypalmitate, stearic acid, arachidic acid, oleic acid, stearic acid, sodium stearat, calcium stearate, magnesium stearate, hydroxyoctacosanyl hydroxystearate, oleate esters of long-chain, esters of fatty acids, fatty alcohols, esterified fatty diols, hydroxylated fatty acid, hydrogenated fatty acid (saturated or partially saturated fatty acids), partially hydrogenated soybean, partially hydrogenated cottonseed oil, aliphatic alcohols, phospholipids, lecithin, phosphathydil cholin, triesters of fatty acids, coconut oil, hydrogenated coconut oil, cacao butter; palm oil; fatty acid eutectics; mono and diglycerides, poloxamers, block-co-polymers of polyethylene glycol and polyesters, and a combination thereof.

According to some embodiments, the wax may comprise one or more of beeswax, carnauba wax, japan wax, bone wax, paraffin wax, chinese wax, lanolin (wool wax), shellac wax, spermaceti, bayberry wax, candelilla wax, castor wax, esparto wax, jojoba oil, ouricury wax, rice bran wax, soy wax, ceresin waxes, montan wax, ozocerite, peat waxes, microcrystalline wax, petroleum jelly, polyethylene waxes, Fischer-Tropsch waxes, chemically modified waxes, substituted amide waxes; polymerized α-olefins, or a combination thereof.

According to some embodiments, the solid fat or fatty acid may include at least one of lauric acid, hydrogenated coconut oil, cacao butter, stearic acid, or a combination thereof.

According to some demonstrative embodiments of the present invention there is provided a composition comprising a core comprising at least one oxygen-sensitive liquid natural pharmaceutically or nutritionally active agent embedded into a melt matrix comprising one or more of stearic acid and/or a PEG based polymer; at least one intermediate coating layer comprising a polymer in an aqueous solution of 0.1% having a surface tension lower than 60 mN/m measured at 25° C.; at least one coating layer comprising a polymer having oxygen transmission rate of less than 1000 cc/m²/24 hr measured at standard test conditions and a water vapor transmission rate of less than 400 g/m²/day; andat least one delayed release layer comprising an enteric polymer.

According to some embodiments, the PEG based polymer may comprise a PEG based co-polymer.

According to some embodiments, the composition may be adapted for admixing with a food product.

According to some embodiments, the composition may further comprise a stabilizer, selected from the group consisting of dipotassium edetate, disodium edetate, edetate calcium disodium, edetic acid, fumaric acid, malic acid, maltol, sodium edetate, trisodium edetate.

According to some embodiments, the composition may further comprise an oxygen scavenger selected from the group including L-cysteine base or hydrochloride, vitamin E, tocopherol or polyphenols.

According to some embodiments, the composition may further comprise a surfactant in any of the coating layers, with the proviso that the surfactant is not present in the core.

According to some embodiments, the composition may further comprise a surfactant in the core, with the proviso that the surfactant is not part of an emulsion.

According to some embodiments, the surfactant may be selected from the group including tween 80, docusate sodium, sodium lauryl sulfate, glyceryl monooleate, polyoxyethylene sorbitan fatty acid esters, polyvinyl alcohol and sorbitan esters.

According to some embodiments, the composition may further comprise a glidant.

According to some embodiments, the glidant is silicon dioxide.

According to some embodiments, the composition may further comprise a plasticizer selected from the group including polyethylene glycol (PEG), e.g., PEG 400, triethyl citrate and triacetin.

According to some embodiments, the composition may further comprise a filler selected from the group including microcrystalline cellulose, a sugar, such as lactose, glucose, galactose, fructose, or sucrose; dicalcium phosphate; sugar alcohols such as sorbitol, manitol, mantitol, lactitol, xylitol, isomalt, erythritol, and hydrogenated starch hydrolysates; corn starch and potato starch.

According to some embodiments, the composition may further comprise a binder selected from the group including Povidone (PVP: polyvinyl pyrrolidone), Copovidone (copolymer of vinyl pyrrolidone and vinyl acetate), polyvinyl alcohol, low molecular weight HPC (hydroxypropyl cellulose), low molecular weight HPMC (hydroxypropyl methylcellulose), low molecular weight hydroxymethyl cellulose (MC), low molecular weight sodium carboxy methyl cellulose, low molecular weight hydroxyethylcellulose, low molecular weight hydroxymethylcellulose, cellulose acetate, gelatin, hydrolyzed gelatin, polyethylene oxide, acacia, dextrin, starch, and water soluble polyacrylates and polymethacrylates and low molecular weight ethylcellulose.

According to some demonstrative embodiments of the present invention there is provided a method of producing a stabilized, multi-layered particle containing oxygen-sensitive liquid natural pharmaceutically or nutritionally active agent, comprising preparing a core from an oxygen-sensitive liquid natural pharmaceutically or nutritionally active agent and an absorbent; coating the core with a first coating layer to obtain a water sealed coated particle, the first coating layer comprising a hydrophobic solid fat or fatty acid, the first coating layer preventing penetration of water into said core; coating said water sealed coated particle with an intermediate coating layer that adjusts interfacial tension to obtain a water sealed coated particle having an adjusted surface tension; and coating said water sealed coated particle having an adjusted surface tension with a barrier coating layer that reduces transmission of oxygen and humidity into the core granule to obtain a multi-layered particle containing oxygen-sensitive liquid natural pharmaceutically or nutritionally active agent.

According to some embodiments, the intermediate coating layer may include an aqueous solution of 0.1% and having a surface tension less than 60 mN/m as measured at 25° C.

According to some embodiments, the surface tension may be lower than 50 mN/m.

According to some embodiments, the surface tension may be lower than 45 mN/m.

According to some embodiments, the at least one barrier coating layer may comprise a polymer having oxygen transmission rate of less than 1000 cc/m²/24 hr measured at standard test conditions.

According to some embodiments, the at least one barrier coating layer may comprise a polymer having oxygen transmission rate of less than 500 cc/m²/24 hr measured at standard test conditions.

According to some embodiments, the at least one barrier coating layer may comprise a polymer having oxygen transmission rate of less than 100 cc/m2/24 hr measured at standard test conditions.

According to some embodiments, the at least one barrier coating layer may comprise a polymer having a water vapor transmission rate of less than 400 g/m²/day.

According to some embodiments, the at least one barrier coating layer may comprise a polymer having a water vapor transmission rate of less than 350 g/m²/day.

According to some embodiments, the at least one barrier coating layer may comprise a polymer having a water vapor transmission rate of less than 300 g/m²/day.

### BRIEF DESCRIPTION OF THE DRAWINGS

FIG. 1 demonstrates an exemplary flow diagram for the compositions described herein in accordance with some demonstrative embodiments.

FIG. 2 demonstrates an exemplary schema of a multiple-layered microencapsulated oxygen-sensitive liquid natural pharmaceutically or nutritionally active agent in accordance with some embodiments described herein.

FIG. 3 demonstrates an exemplary schema of a multiple-layered microencapsulated oxygen-sensitive liquid natural pharmaceutically or nutritionally active agent in accordance with some embodiments described herein.

FIG. 4 demonstrates an exemplary schema of a contact angle (θ) formed when a liquid, according to some demonstrative embodiments described herein, does not completely spread on a substrate.

FIG. 5 demonstrates an exemplary illustration of the effect of capillarity describing the flow of a penetrant through void or pore on the surface of a solid described herein in accordance with some demonstrative embodiments.

FIG. 6 demonstrates an exemplary oxidation test results in accordance with some embodiments described herein.

FIG. 7 demonstrates an accelerated stability test carried out using ML OXIPRES™ test method in accordance with some embodiments described herein.

### DESCRIPTION OF THE PREFERRED EMBODIMENTS

The present invention, in at least some embodiments, is of new compositions and methods for improving stability and extending shelf life of sensitive food additives and food products thereof.

According to some demonstrative embodiments of the present invention there is provided a composition that may be used as a supplement and/or food additive, for example, to be added into a food product, including, e.g., engineered foods and functional foods such as creams, biscuits, biscuit fill-ins, chocolates, sauces, mayonnaise, cereals, baked goods and the like. Food additives, such as liquid natural pharmaceutically or nutritionally active agents and/or other nutraceutical agents, may include foods or food products that provide health and medical benefits, may be sensitive to oxygen (i.e., they are oxidizable). Such products may range from isolated nutrients, oil products, dietary supplements, food additives, engineered foods, herbal extracted products, and processed foods such as functional food, as described above, and the like.

In some demonstrative embodiments, the composition may comprise a core having at least one oxygen-sensitive liquid natural pharmaceutically or nutritionally active agent absorbed or adsorbed onto a substrate and at least one coating layer designed to stabilize the oxygen-sensitive liquid natural pharmaceutically or nutritionally active agent.

According to some demonstrative embodiments, the at least one oxygen-sensitive liquid natural pharmaceutically or nutritionally active agent may include, but not limited to, fatty acids, for example, unsaturated fatty acids, omega 3 fatty acids, omega 6 fatty acids, and omega 9 fatty acids, α-linolenic acid (18:3, n-3; ALA), eicosapentaenoic acid (20:5, n-3; EPA), docosahexaenoic acid (22:6, n-3; DHA), oleic acid, fish oil, flax oil, olive oil, ginseng extract, garlic oil, alliin, allicin, and/or the like.

The term n-3 (also called ω-3 or omega-3) as referred to herein signifies that the first double bond exists as the third carbon-carbon bond from the terminal methyl end (n) of the carbon chain n-3 fatty acids which are important in human nutrition such as α-linolenic acid (18:3, n-3; ALA), eicosapentaenoic acid (20:5, n-3; EPA), docosahexaenoic acid (22:6, n-3; DHA). These three polyunsaturates have either 3, 5 or 6 double bonds in a carbon chain of 18, 20 or 22 carbon atoms, respectively. All double bonds are in the cis-configuration; in other words, the two hydrogen atoms are on the same side of the double bond.

In some demonstrative embodiments of the present invention, the composition described herein may include one or more coated particles, comprising at least three layered phases, such as, by way of non-limiting example, a core and at least three coats (“coating layers”).

In some embodiments, one of the coats may be a hydrophobic solid fat formulated to contribute to the prevention of water/humidity penetration into the core, e.g., during the process of coating of other coating layers or during later stages.

In some embodiments, the composition may also include an outer coat which may be formulated to prevent or diminish transmission of humidity and/or oxygen into the core, e.g., during the storage and throughout the shelf life of the food product.

In some embodiments, the composition may also include a third coat which is an intermediate coating layer, which may be formulated to provide and/or promote binding and/or adhesion of the previous coats to each other. According to some embodiments, the intermediate coat may further provide oxygen and/or humidity resistance to the core.

According to some demonstrative embodiments, the three coating layers described hereinabove may include substantially the same chemical polymers with either same or different viscosities or molecular weights.

Without wishing to be limited to a single hypothesis, in some embodiments, it may be one of the layers described above that contributes maximally to the resistance of oxygen/humidity penetration into the core. However, according to some embodiments, the composition of the present invention may include additional layers that may contribute to the stability of the oxygen-sensitive liquid natural pharmaceutically or nutritionally active agents, during the process or method descried below and/or during the storing said food and/or during digestion and passage through the gastrointestinal (GI) tract.

The Core

In some demonstrative embodiments, the core may be in the form of one or more granules, particles or a solid powder and may optionally be coated by a plurality of coating layers, e.g., as described in detail below.

According to some embodiments, the granules may be prepared using a fluidized bed technology, such as by way of non-limiting example: Glatt or turbo jet, Glatt or an Innojet coater/granulator, a Huttlin coater/granulator, a Granulex, and/or the like.

According to some demonstrative embodiments, the core may include a mixture of the at least one oxygen-sensitive liquid natural pharmaceutically or nutritionally active agent and at least one excipient, including at least one of an absorbent, a stabilizer, an antioxidant (“oxygen scavenger”), a filler, a plasticizer, a surfactant (also referred to as a “surface free energy-lowering agent”), a binder and optionally a hydrophobic solid fat or fatty acid is in a melt state and/or any other suitable excipient, e.g., as described herein.

According to some embodiments, the mixture may be absorbed or adsorbed onto a substrate to obtain the core. Although the mixture may optionally comprise an emulsion, according to preferred embodiments the mixture does not comprise an emulsion and in fact does not feature an emulsion. Optionally, the mixture consists essentially of the oxygen-sensitive liquid natural pharmaceutically or nutritionally active agent, without any added material. Alternatively, the mixture features the oxygen-sensitive liquid natural pharmaceutically or nutritionally active agent in the form of a suspension, whether a liquid or dry suspension. Also alternatively, the mixture features the oxygen-sensitive liquid natural pharmaceutically or nutritionally active agent in a solid dispersion, for example and without limitation a melt. Optionally and more preferably, the melt comprises stearic acid and/or a PEG based polymer, which may optionally comprise a PEG based co-polymer, optionally without a substrate for absorbing the melt.

According to some demonstrative embodiments, the total amount of the at least one oxygen-sensitive liquid natural pharmaceutically or nutritionally active agent in the mixture is from about 10% to about 90% by weight of the core.

The Absorbent

According to some embodiments, the core may include at least one absorbent compound which is porous (also referred to herein as a “substrate”).

According to some embodiments, the absorbent may be responsible for absorbing and/or adsorbing the at least one oxygen-sensitive liquid natural pharmaceutically or nutritionally active agent by capillary action and/or capillary force.

According to other embodiments, the absorbent is meant to be coated by a mixture which comprises the at least one oxygen-sensitive liquid natural pharmaceutically or nutritionally active agent and at least one solid fat or solid fatty acid. According to some embodiments, the solid fat or solid fatty acid may have a melting point of below 50° C., including, for example, lauric acid and/or cacao butter.

In some embodiments, the higher the capillary force, the more effective the absorbance and/or adsorbance. As discussed herein, capillarity or capillary action is a phenomenon in which the surface of a liquid is observed to be elevated or depressed where it comes into contact with a solid. Capillarity is spontaneous movement of liquids up or down narrow tubes, or pores existing in the surface of a solid as a part of its surface texture. As discussed herein, capillary action is a physical effect caused by the interactions of a liquid with the walls of a thin tube or pores existing in the surface of a solid, and the capillary effect is a function of the ability of the liquid to wet a particular material.

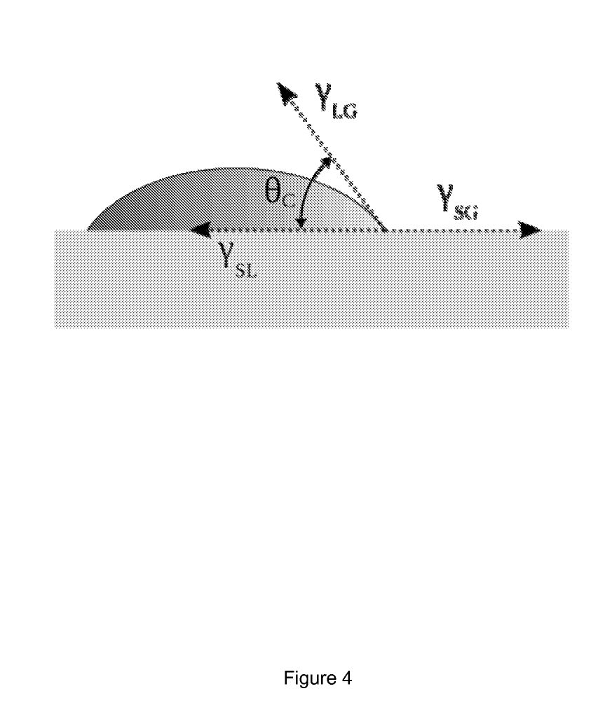

According to some embodiments, as discussed with respect to the composition described herein, an important characteristic of a liquid penetrant material is its ability to freely wet the surface of a target object. At the liquid-solid surface interface, if the molecules of the liquid have a stronger attraction to the molecules of the solid surface than to each other (i.e., the adhesive forces are stronger than the cohesive forces), wetting of the surface occurs. Alternately, if the liquid molecules are more strongly attracted to each other than the molecules of the solid surface (i.e., the cohesive forces are stronger than the adhesive forces), the liquid beads-up and does not wet the surface. One way to quantify a liquid's surface wetting characteristics is to measure the contact angle of a drop of liquid placed on the surface of an object. The contact angle is the angle formed by the solid/liquid interface and the liquid/vapor interface measured from the side of the liquid (FIG. 4). Liquids wet surfaces when the contact angle is less than 90 degrees. For a penetrant material to be effective, the contact angle should be as small as possible.

Wetting ability of a liquid is a function of the surface energies of the solid-gas interface, the liquid-gas interface, and the solid-liquid interface. The surface energy across an interface or the surface tension at the interface is a measure of the energy required to form a unit area of new surface at the interface. The intermolecular bonds or cohesive forces between the molecules of a liquid cause surface tension. When the liquid encounters another substance, there is usually an attraction between the two materials. The adhesive forces between the liquid and the second substance will compete against the cohesive forces of the liquid. Liquids with weak cohesive bonds and a strong attraction to another material (or the desire to create adhesive bonds) will tend to spread over the material. Liquids with strong cohesive bonds and weaker adhesive forces will tend to bead-up or form a droplet when in contact with another material.

In liquid penetrant testing, there are usually three surface interfaces involved, the solid-gas interface, the liquid-gas interface, and the solid-liquid interface. For a liquid to spread over the surface of a part, two conditions must be met. First, the surface energy of the solid-gas interface must be greater than the combined surface energies of the liquid-gas and the solid-liquid interfaces. Second, the surface energy of the solid-gas interface must exceed the surface energy of the solid-liquid interface.

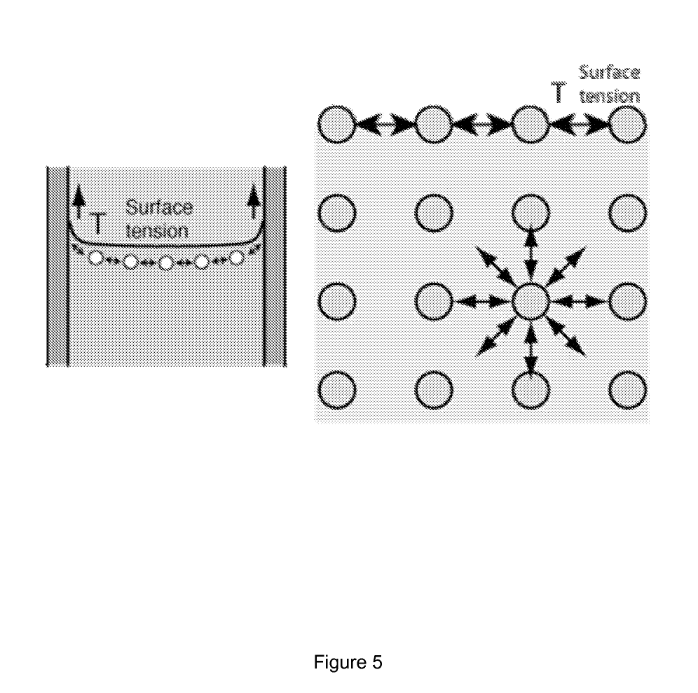

A penetrant's wetting characteristics are also largely responsible for its ability to fill a void or pore. Penetrant materials are often pulled into surface breaking defects by capillary action, which may be defined as the movement of liquid within the spaces of a porous material due to the forces of adhesion, cohesion, and surface tension. Capillarity can be explained by considering the effects of two opposing forces: adhesion, the attractive (or repulsive) force between the molecules of the liquid and those of the solid, and cohesion, the attractive force between the molecules of the liquid. The size of the capillary action depends on the relative magnitudes cohesive forces within the liquid and the adhesive forces operating between the liquid and the pore walls (FIG. 5).

The forces of cohesion act to minimize the surface area of the liquid. When the cohesive force, acting to reduce the surface area becomes equal to the adhesive force acting to increase it, equilibrium is reached and the liquid stops rising where it contacts the solid. Therefore the movement is due to unbalanced molecular attraction at the boundary between the liquid and the solid pores wall. If liquid molecules near the boundary are more strongly attracted to molecules in the material of the solid than to other nearby liquid molecules, the liquid will rise in the tube. If liquid molecules are less attracted to the material of the solid than to other liquid molecules, the liquid will fall. The energetic gain from the new intermolecular interactions must be balanced against gravity, which attempts to pull the liquid back down.

The capillary force driving the penetrant into the crack, voids or pores is a function of the surface tension of the liquid-gas interface (σ), the contact angle with the solid surface, and the size of the defect opening (pore diameter (d) or radius (r)). The driving force for the capillary action can be expressed as the following formula:

Force=2πrσLG cos θ

Where:
r=radius of the pore/void opening (2πr is the line of contact between the liquid
and the solid tubular surface.)
σLG=liquid-gas surface tension
θ=contact angle

Since pressure is the force over a given area, it can be written that the pressure developed, called the capillary pressure, is

Capillary Pressure=(2σLG cos θ)/r

The above equations are for a cylindrical defect but the relationships of the variables are the same for a flaw with a noncircular cross section. Capillary pressure equations only apply when there is simultaneous contact of the penetrant along the entire length of the crack opening and a liquid front forms that is equidistant from the surface. A liquid penetrant surface could take-on a complex shape as a consequence of the various deviations from flat parallel walls that an actual pore could have. In this case, the expression for pressure is

Capillary Pressure=2(σSG−σSL)/r=2Σ/r

Where:
σSG=the surface energy at the solid-gas interface.
σSL=the surface energy at the solid-liquid interface.
r=the radius of the pore opening.
Σ=the adhesion tension (σSG−σSL).

Adhesion tension is the force acting on a unit length of the wetting line from the direction of the solid. The wetting performance of the penetrant is degraded when adhesion tension is the primary driving force.

As demonstrated by equations, the surface wetting characteristics (defined by the surface energies) are important in order for a penetrant to fill a void. A liquid penetrant will continue to fill the void until an opposing force balances the capillary pressure. This force is usually the pressure of trapped gas in a void, as most flaws are open only at the surface of the part. Since the gas originally in a flaw volume cannot escape through the layer of penetrant, the gas is compressed near the closed end of a void.

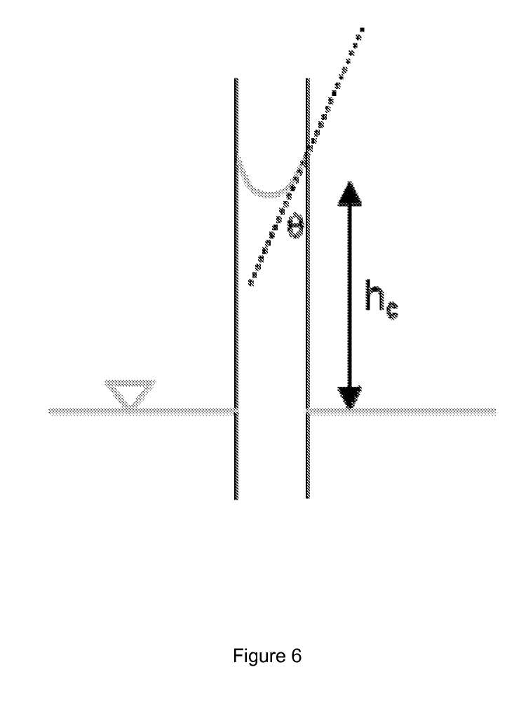

Since the contact angle for penetrants is very close to zero, other methods have been devised to make relative comparisons of the wetting characteristics of these liquids. One method is to measure the height that a liquid reaches in a capillary tube (FIG. 6).

Capillary rise (height) (hc) is a function of the surface tension of the liquid-gas interface (σ), the contact angle with the solid surface, the size of the defect opening (pore diameter (d)) and specific weights (γL, γG) of liquid and gas. The capillary rise (height) as a result of the capillary action can be expressed as the following formula:

hc=4σ cos(θ)/(γL−γG)d

Since for liquid-vapour interfaces σL>>σG, the equation reduces to:

hc=4σ cos(θ)/γLd

Therefore, the narrower the tube or the smaller the diameter of pore, the higher the liquid will climb or be absorbed or adsorbed, because a narrow column of liquid weighs less than a thick one. Likewise the denser a liquid is, the less likely it is to demonstrate capillarity. Capillary action is also less common with liquids which have a very high level of cohesion, because the individual molecules in the fluid are drawn more tightly to each other than they are to an opposing surface. Eventually, capillary action will also reach a balance point, in which the forces of adhesion and cohesion are equal, and the weight of the liquid holds it in place. As a general rule, the smaller the tube, the higher up it the fluid will be drawn. Cohesion force is due to the relative attraction among molecules in a fluid. Since this attraction decreases with increases temperature, the surface tension reduces with increases temperature.

Viscous Flows

Since many of oxygen-sensitive liquid natural pharmaceutically or nutritionally active agents, such as unsaturated fatty acids, omega 3 fatty acids, omega 6 fatty acids, and omega 9 fatty acids, α-linolenic acid (18:3, n-3; ALA), eicosapentaenoic acid (20:5, n-3; EPA), docosahexaenoic acid (22:6, n-3; DHA), oleic acid, fish oil, flax oil, olive oil, etc., are viscous liquids, the flow rate of such oxygen-sensitive liquid natural pharmaceutically or nutritionally active agents through pores, void, crack will be also dependent on their viscosity. Viscosity is like the internal friction of a fluid. Liquids flow fastest in the center and tend to zero as the wall of the pore is approached. The viscous force is the force necessary to move the top solid surface confining a fluid, when the bottom surface does not move. That force is proportional to the surface area, A, and the velocity, v, and inversely proportional to the distance, d, from the non-moving surface:

F=ηAv/d

η=viscosity of penetrant

The constant coefficient is called coefficient of viscosity, measured in N*s/m2, and it depends on the type of fluid. It is 1.0×10−3 for water at 20° C. In the cgs system the units of η are dyne*s/cm2=1 poise (from Poiseuille). The conversion is 1 poise=10−1 Ns/m2, so the coefficient of viscosity of water is also 0.01 poise=1 cp (centipoise).

The flow rate of a penetrant through void, crack, or pore existing on the surface a solid may be obtained through Poiseuille' s Law, as follows:

v=Δh/Δt=ΔV/Δt

Where
h=capillary height
v=flow rate
V=volume of penetrant flowing on a pore
t=time

and the rate of flow through a pore of A as:

vA=AΔh/Δt=ΔV/Δt

Where
A=cross sectional area of pore or void

It can be seen that the rate of flow is proportional to the volume of fluid flowing on a pore per unit time.

Poiseuille's law relates this rate of flow to the difference in the pressure, per unit length in the pore (L), necessary to move the flow into the pore:

Rate of Flow=ΔV/Δt=πr4(P1−P2)/(8ηh)

Where:
P1 and P2 are the pressure on the both sides of the pore with opening radius of r separated by a distance h
η=viscosity of penetrant

Notice that if the viscosity is larger, a larger force (a large pressure difference) is needed to push the fluid through the pore or void. More importantly, if there is a restriction, the flow rate decreases as r. So the flow rate of the penetrant is smaller on the small diameter voids or pores than on large diameter ones.

The importance of viscosity can be seen based on Reynolds Number. If the flow velocity is large enough and viscosity low enough, the flow may go from laminar (smooth) to turbulent (vortices). This happens experimentally when a non-dimensional parameter, called the Reynolds number, becomes larger than 2,000-3,000. The Reynolds number is defined as:

Re=ρvr/η

Where:
v is the flow velocity for example through a pore of diameter r,
ρ is the density of the fluid, and
η is the coefficient of viscosity.

It can be seen that the Reynolds number measures the ratio of the momentum of the fluid per unit volume (ρv instead of mv), and the viscosity per unit length. When the momentum in the flow is too large compared to the viscosity, the flow is unstable and it becomes chaotic and forms vortices that cannot be dissipated effectively by viscosity. In other words, viscosity is what keeps the flow ordered, and without enough of it, the motion of fluids becomes erratic.

According to some embodiments of the composition described herein, the absorbent may be a water insoluble material possessing highly porosity and proper surface tension enabling first the absorption and/or adsorption of an emulsion comprising the at least one oxygen-sensitive liquid natural pharmaceutically or nutritionally active agent, water and a surfactant and later the absorption of the oxygen-sensitive liquid natural pharmaceutically or nutritionally active agent alone when the water is totally evaporated.

According to other embodiments, the composition described herein, the absorbent may include a suitable porosity to enable the absorption of a non-emulsion form of the at least one oxygen-sensitive liquid natural pharmaceutically or nutritionally active agent. According to these embodiments, when the least one oxygen-sensitive liquid natural pharmaceutically or nutritionally active agent is not in the form of an emulsion there is no need to use a surfactant in the core of the composition described herein.

Advantageously, if a surfactant is not used and an emulsion is not prepared, then the oxygen-sensitive liquid pharmaceutically or nutritionally active agent does not need to be heated when preparing the core, or at least does not need to be heated concomitantly with exposure to oxygen.

According to some embodiments, examples of a suitable absorbent include, but are not limited to, microcrystalline cellulose (MCC), silicon dioxide, lactose, talc, aluminum silicate, dibasic calcium phosphate anhydrous, starch or a starch derivative, a polysaccharide or a combination thereof. Optionally, the starch derivative comprises one or more of partially pregelatinized starch, pregelatinized starch, starch phosphate, modified food starch, or a combination thereof. Optionally the polysaccharide comprises one or more of glucose-based polysaccharides/glucan including glycogen, starch (amylose, amylopectin), cellulose, mannose-based polysaccharides (mannan), galactose-based polysaccharides (galactan), N-acetylglucosamine-based polysaccharides including chitin, gums such as arabic gum (gum acacia), modified polysaccharides such as crosslinked pectin, cross linked sodium alginate; cellulose derivatives such as ethyl cellulose, propyl cellulose, cross-linked cellulose derivatives and a combination thereof.

The Stabilizer

According to some embodiments, the at least one oxygen-sensitive liquid natural pharmaceutically or nutritionally active agent may be mixed in the core with at least one stabilizer.

In some demonstrative embodiments, the stabilizer may be selected from the group consisting of dipotassium edetate, disodium edetate, edetate calcium disodium, edetic acid, fumaric acid, malic acid, maltol, sodium edetate, trisodium edetate.

The Antioxidant (“Oxygen Scavenger”).

According to some embodiments, the at least one oxygen-sensitive liquid natural pharmaceutically or nutritionally active agent may be mixed in the core with at least one antioxidant.

In some demonstrative embodiments, the antioxidant may be selected from the group consisting of L-cysteine hydrochloride, L-cysteine base, 4,4(2,3 dimethyl tetramethylene dipyrocatechol), tocopherol-rich extract (natural vitamin E), α-tocopherol (synthetic Vitamin E), β-tocopherol, γ-tocopherol, δ-tocopherol, butylhydroxinon, butyl hydroxyanisole (BHA), butyl hydroxytoluene (BHT), propyl gallate, octyl gallate, dodecyl gallate, tertiary butylhydroquinone (TBHQ), fumaric acid, malic acid, ascorbic acid (Vitamin C), sodium ascorbate, calcium ascorbate, potassium ascorbate, ascorbyl palmitate, and ascorbyl stearate.

According to some demonstrative embodiments of the present invention, the core may comprise both a stabilizer and an antioxidant. Stabilizing agents and antioxidants may optionally be differentiated. For example, the antioxidant may be L-cysteine hydrochloride or L-cysteine base or tocopherol or polyphenols and/or a combination thereof whereas the stabilizer may be dipotassium edetate.

The Surfactant

According to some embodiments, the at least one oxygen-sensitive liquid natural pharmaceutically or nutritionally active agent may be mixed in the core with at least one surfactant.

In some demonstrative embodiments, the surfactant may be an emulsifier (emulsifying agent), suspending agent, dispersing agent, and/or any other food grade surface active agents, such as, by way of non-limiting example, tween 80, docusate sodium, sodium lauryl sulfate, glyceryl monooleate, polyoxyethylene sorbitan fatty acid esters, polyvinyl alcohol, sorbitan esters, etc., and/or a combination thereof. Optionally and more preferably, if a surfactant is used, it is used in the core without forming an emulsion with the oxygen-sensitive pharmaceutically or nutritionally active agent. According to at least some embodiments, alternatively a surfactant is present in one or more of the coating layers but is not present in the core.

The Glidant

According to some embodiments, the at least one oxygen-sensitive liquid natural pharmaceutically or nutritionally active agent may be mixed in the core with at least one glidant.

In some demonstrative embodiments, the glidant may be silicon dioxide, a metal stearate or stearic acid, or a combination thereof. The metal stearate may optionally comprise sodium or magnesium stearate.

The Plasticizer

According to some embodiments, the plasticizer described herein may be selected from the group consisting of polyethylene glycol (PEG), e.g., PEG 400, triethyl citrate, triacetin and the like.

The Filler

According to some embodiments of the present invention, the filler referred to herein, may be selected from, but not limited to the group including microcrystalline cellulose, a sugar, such as lactose, glucose, galactose, fructose, or sucrose; dicalcium phosphate; sugar alcohols such as sorbitol, manitol, mantitol, lactitol, xylitol, isomalt, erythritol, and hydrogenated starch hydrolysates; corn starch; and potato starch; and/or a mixture or mixtures thereof. Preferably, the filler is lactose.

The Binder

According to some embodiments of the present invention, the binder referred to herein, may be selected from, but not limited to the group including Povidone (PVP: polyvinyl pyrrolidone), Copovidone (copolymer of vinyl pyrrolidone and vinyl acetate), polyvinyl alcohol, low molecular weight HPC (hydroxypropyl cellulose), low molecular weight HPMC (hydroxypropyl methylcellulose), low molecular weight hydroxymethyl cellulose (MC), low molecular weight sodium carboxy methyl cellulose, low molecular weight hydroxyethylcellulose, low molecular weight hydroxymethylcellulose, cellulose acetate, gelatin, hydrolyzed gelatin, polyethylene oxide, acacia, dextrin, starch, and water soluble polyacrylates and polymethacrylates, low molecular weight ethylcellulose or a mixture thereof. Preferably, the filler is low molecular weight HPMC.

The Hydrophobic Solid Fat or Fatty Acid

According to some embodiments, the hydrophobic solid fat or fatty acid as described herein, may have a melting point lower than 70° C. and higher than 25° C., preferably lower than 65° C. and higher than 30° C., more preferably lower than 60° C. and higher than 35° C.

As used herein the term “fat” or “fats” includes of a wide group of hydrophobic compounds that are generally soluble in organic solvents and largely insoluble in water. Chemically, fats are generally triesters of glycerol and fatty acids. Fats may be either solid or liquid at room temperature, depending on their structure and composition. Although the words “oils”, “fats”, and “lipids” are all used to refer to fats, “oils” is usually used to refer to fats that are liquids at normal room temperature, while “fats” is usually used to refer to fats that are solids at normal room temperature. “Lipids” is used to refer to both liquid and solid fats, along with other related substances. The word “oil” is used for any substance that does not mix with water and has a greasy feel, such as petroleum (or crude oil) and heating oil, regardless of its chemical structure. Examples of fats according to the present invention include but are not limited to fats as described above, fatty acids, fatty acid esters, fatty acid triesters, salts of fatty acids such as aluminum, sodium, potassium and magnesium salts, fatty alcohols, phospholipids, solid lipids, waxes, lauric acid, stearic acid, alkenes, waxes, fatty acids and their salts and alcohol esters, long chain alcohols and glucoles, and combinations thereof.

Non-limiting examples of such materials include alkenes such as paraffin wax which is composed of a chain of alkenes, normal paraffins of type CnH2n+2 which are a family of saturated hydrocarbons which are waxy solids having melting point in the range of 23-67 oC (depending on the number of alkanes in the chain); natural waxes (which are typically esters of fatty acids and long chain alcohols) and synthetic waxes (which are long-chain hydrocarbons lacking functional groups) such as beeswax, carnauba wax, japan wax, bone wax, paraffin wax, chinese wax, lanolin (wool wax), shellac wax, spermaceti, bayberry wax, candelilla wax, castor wax, esparto wax, jojoba oil, ouricury wax, rice bran wax, soy wax, ceresin waxes, montan wax, ozocerite, peat waxes, microcrystalline wax, petroleum jelly, polyethylene waxes, Fischer-Tropsch waxes, chemically modified waxes, substituted amide waxes; polymerized α-olefins; hydrogenated vegetable oil, hydrogenated castor oil; fatty acids, such as lauric acid, myristic acid, palmitic acid, palmitate, palmitoleate, hydroxypalmitate, stearic acid, arachidic acid, oleic acid, stearic acid, sodium stearat, calcium stearate, magnesium stearate, hydroxyoctacosanyl hydroxystearate, oleate esters of long-chain, esters of fatty acids, fatty alcohols, esterified fatty diols, hydroxylated fatty acid, hydrogenated fatty acid (saturated or partially saturated fatty acids), partially hydrogenated soybean, partially hydrogenated cottonseed oil, aliphatic alcohols, phospholipids, lecithin, phosphathydil cholin, triesters of fatty acids for example triglycerides received from fatty acids and glycerol (1,2,3-trihydroxypropane) including fats and oils such as coconut oil, hydrogenated coconut oil, cacao butter (also called theobroma oil or theobroma cacao); palm oil; eutectics such as fatty acid eutectics which are a mixture of two or more substances which both possess reliable melting and solidification behaviour; mono and diglycerides, poloxamers which are block-co-polymers of polyethylene oxide and polypropylene glycol (Lutrol F), block-co-polymers of polyethylene glycol and polyesters, and a combination thereof.

According to some embodiments, the solid fat or fatty acid is at least one of lauric acid, hydrogenated coconut oil, cacao butter, stearic acid, and/or a combination thereof.

According to some embodiments, the hydrophobic solid fat or fatty acid may be capable of forming a stable hydrophobic film, as described in detail herein.

Alternatively, said hydrophobic fat or fatty acid may be capable of forming a matrix in which an oxygen-sensitive liquid natural pharmaceutically or nutritionally active agent core granules or particles are embedded.

According to yet another embodiment, the hydrophobic solid fat or fatty acid, e.g., in a melt form, may be mixed with an oxygen-sensitive liquid natural pharmaceutically or nutritionally active agent, and optionally, a stabilizer, to form a uniform mixture. According to these embodiments, the mixture may be added to an absorbent to form core particles or granules or an absorbent coated with a film of the mixture. If core particles or granules are formed, the core particles or granules include the oxygen-sensitive liquid natural pharmaceutically or nutritionally active agent and said absorbent. If an absorbent coated with a film of the mixture is formed, the film includes the solid fat or fatty acid and the oxygen-sensitive liquid natural pharmaceutically or nutritionally active agents and the stabilizer as a mixture onto or around the absorbent.

The First Coating Layer

In some demonstrative embodiments, the composition may include a first coating layer (also referred to herein as “the fatty coating layer”), which may act as the most inner coating layer coating the core, and which may be formulated to prevent or diminish humidity and/or oxygen penetration into the core, e.g., during the further coating processes, as described below.

According to some embodiments, the first coating layer may include at least one hydrophobic solid fat and/or fatty acid as described hereinabove.

According to some demonstrative embodiments, the at least one hydrophobic solid fat and/or fatty acid may form a stable hydrophobic film or matrix which may embed the core containing the at least one oxygen-sensitive liquid natural pharmaceutically or nutritionally active agent.

According to other embodiments of the present invention, the at least one hydrophobic solid fat and/or fatty acid may form a film directly around the oxygen sensitive liquid natural pharmaceutically or nutritionally active agent core particles, e.g., when being in the form of granules.

The Intermediate Coating Layer

In some demonstrative embodiments, the composition may include an intermediate coating layer. In some embodiments, as described in detail below, the intermediate coating layer may be formulated to provide and/or promote binding and/or adhesion of the previous coats to each other. According to some embodiments, the intermediate coat may further provide oxygen and/or humidity resistance to the core.

According to some embodiments, the intermediate coating layer may include an aqueous solution of 0.1% and have a surface tension lower than 60 mN/m, preferably lower than 50 mN/m and more preferably lower than 45 mN/m (measured at 25° C.).

According to some embodiments, the intermediate coating layer may include at least one interfacial tension adjusting polymer, and accordingly may be used for adjusting the surface tension for further coating with an outer coating layer, as described in detail below. The interfacial tension adjusting polymer is preferably characterized by an aqueous solution of 0.1% having a surface tension lower than 60 mN/m when measured at 25 C.

As discussed herein, surface tension (ST) is a property of the surface of a liquid that allows it to resist an external force, that is, surface tension is the measurement of the cohesive (excess) energy present at a gas/liquid interface. The molecules of a liquid attract each other. The interactions of a molecule in the bulk of a liquid are balanced by an equally attractive force in all directions. Molecules on the surface of a liquid experience an imbalance of forces as indicated below. The net effect of this situation is the presence of free energy at the surface. The excess energy is called surface free energy and can be quantified as a measurement of energy/area. It is also possible to describe this situation as having a line tension or surface tension, which is quantified as a force/length measurement. The common units for surface tension are dynes/cm or mN/m (these units are equivalent).

Polar liquids, such as water, have strong intermolecular interactions and thus high surface tensions. Any factor which decreases the strength of this interaction will lower surface tension. Thus an increase in the temperature of this system will lower surface tension. Any contamination, especially by surfactants, will lower surface tension and lower surface free energy. Some surface tension values of common liquids and solvents are shown in the following table.

| | γ | γp | γd |
|---|---|---|---|
| Substance | (mN/m) | (mN/m) | (mN/m) |
| Water | 72.8 | 51.0 | 21.8 |
| Glycerol | 64 | 30 | 34 |
| Ethylene glycol | 48 | 19 | 29 |
| Dimethyl sulfoxide | 44 | 8 | 36 |
| Benzyl alcohol | 39 | 11.4 | 28.6 |
| Toluene | 28.4 | 2.3 | 26.10 |
| Hexane | 18.4 | — | 18.4 |
| Acetone | 23.7 | — | 23.7 |
| Chloroform | 27.15 | — | 27.15 |
| Diiodomethane | 50.8 | — | 50.8 |

The adhesion and uniformity of a film are also influenced by the forces which act between the coating formulation that is in a solution form and the core surface of the film coated surface. Therefore, coating formulations for certain core surface can be optimized via determination of wetting behavior, the measure of which is the contact or wetting angle. This is the angle that forms between a liquid droplet and the surface of the solid body to which it is applied.

The adhesion and uniformity of a film are also influenced by the forces which act between the coating formulation which is in a solution form and the core surface of the film coated surface. Therefore, coating formulations for certain core surface can be optimized via determination of wetting behavior, the measure of which is the contact or wetting angle. This is the angle that forms between a liquid droplet and the surface of the solid body to which it is applied.

When a liquid does not completely spread on a substrate (usually a solid) a contact angle (θ) is formed which is geometrically defined as the angle on the liquid side of the tangential line drawn through the three phase boundary where a liquid, gas and solid intersect, or two immiscible liquids and solid intersect. The contact angle is a direct measure of interactions taking place between the participating phases. The contact angle is determined by drawing a tangent at the contact where the liquid and solid intersect.

The contact angle is small when the core surface is evenly wetted by spreading droplets. If the liquid droplet forms a defined angle, the size of the contact angle may be described by the Young-Dupre equation:

γSG−γSL=^{γ}LG cos θ

Where θ=Contact angle
γSG=surface tension of the solid body
γLG=surface tension of the liquid
γSL=interfacial tension between liquid and solid body (cannot typically be
measured directly)

With the aid of this equation it is possible to estimate the surface tension of a solid body by measuring the relevant contact angles. If one measures them with liquid of varying surface tension and plots their cosines as a function of the surface tension of the liquids, the result is a straight line. The abscissa value of the intersection of the straight line with cos θ=1 is referred to as the critical surface tension of wetting γC. A liquid with a surface tension smaller than γC wets the solid in question.

In some embodiments, the wetting or contact angle can be measured by means of telescopic goniometers (e.g. LuW Wettability Tester by AB Lorentzenu. Wettre, S-10028 Stockholm 49). In some cases, the quantity γC does not suffice to characterize polymer surfaces since it depends on, amongst other factors, the polar character of the test liquids. This method can, however, be improved by dividing γ into non-polar part γd (caused by dispersion forces) and a polar part γp (caused by dipolar interactions and hydrogen bonds):

γL=γLp+γLd

γS=γSp+γSd

Where
γL=surface tension of the test liquid
γS=surface tension of the solid body

And γSp and γSd can be determined by means of the following equation:

1+(cos θ/2)(γL/√γLd)=√γSd+√γSp. √(γL−γLd)/γLd

If 1+(cos θ/2)(γL/√γLd) is plotted against √(γL−γLd)/γLd, straight lines are obtained from the slopes and ordinate intercepts of which γSp and γSd can be determined and thus γS calculated. γC and γS are approximately, but not exactly, the same. Since the measurement is also influenced by irregularities of the polymer surfaces, one cannot typically obtain the true contact angle θ but rather the quantity θ′. Both quantities are linked by the relationship:

Roughness factor r=cos θ′/cos θ

The lower the surface tension of the coating formulation against that of the core surface, the better the droplets will spread on the surface. If formulations with organic solvents are used, which may wet the surface very well, the contact angle will be close to zero, and the surface tensions of such formulations are then about 20 to 30 mN/m. Aqueous coating dispersion of some polymer like EUDRAGIT L 30 D type shows low surface tension in the range of 40 to 45 mN/m.

According to some demonstrative embodiments, the contact angle measurements discussed herein with reference to the composition of the present invention provide the following information:
Smaller contact angles give smoother film coatings
The contact angle becomes smaller with decreasing porosity and film former concentration.
Solvents with high boiling point and high dielectric constant reduce the contact angle.
The higher the critical surface tension of core, the better the adhesion of the film to the core.
The smaller the contact angle, the better the adhesion of the film to the core.

The critical surface tension of the core or granules coated with a hydrophobic solid fat is essentially very low. Therefore, for providing better spreading and thus better adhesion of the outer coating layer film to the core there is a need for reducing the surface free energy at the interface between the surface of the fat coated core/granules and the solution of the outer coating layer polymer.

According to some embodiments, the intermediate coating layer may include an aqueous solution of 0.1% having a surface tension lower than 60 mN/m, preferably, lower than 50 mN/m more preferably, lower than 45 mN/m (measured at 25° C.), for reducing the surface free energy at the interface between the surface of the fat coated core/granules and the solution of the outer coating layer polymer.

The following table shows for example the surface tension of the solution of some water soluble polymers. The Surface tension was measured at 25° C., 0.1% aqueous solution of the polymers.

| | Surface Tension |
|---|---|
| Polymer | mN/m |
| Sodium Carboxymethylcellulose (Na- | 71.0 |
| CMC) | |
| Hydroxyethyl cellulose (HEC) | 66.8 |
| Hydroxypropyl cellulose (HPC) | 43.6 |
| Hydroxypropyl methyl cellulose | 46-51 |
| (HPMC) | |
| Hydroxymethyl cellulose (HMC) | 50-55 |

In some demonstrative embodiments, the intermediate coating layer may include, but not limited to, at least one of the following polymers: hyroxypropylmethylcellulose (HPMC), hydroxypropylethylcellulose (HPEC), hydroxypropylcellulose (HPC), methylcellulose, ethylcellulose, pH-sensitive polymers e.g., enteric polymers including phthalate derivatives such as acid phthalate of carbohydrates, amylose acetate phthalate, cellulose acetate phthalate (CAP), other cellulose ester phthalates, cellulose ether phthalates, hydroxypropylcellulose phthalate (HPCP), hydroxypropylethylcellulose phthalate (HPECP), hydroxyproplymethylcellulose phthalate (HPMCP), hydroxyproplymethylcellulose acetate succinate (HPMCAS), methylcellulose phthalate (MCP), polyvinyl acetate phthalate (PVAcP), polyvinyl acetate hydrogen phthalate, sodium CAP, starch acid phthalate, cellulose acetate trimellitate (CAT), styrene-maleic acid dibutyl phthalate copolymer, styrene-maleic acid/polyvinylacetate phthalate copolymer, styrene and maleic acid copolymers, polyacrylic acid derivatives such as acrylic acid and acrylic ester copolymers, polymethacrylic acid and esters thereof, polyacrylic and methacrylic acid copolymers, shellac, and vinyl acetate and crotonic acid copolymers. In some embodiments, pH-sensitive polymers include shellac, phthalate derivatives, CAT, HPMCAS, polyacrylic acid derivatives, particularly copolymers comprising acrylic acid and at least one acrylic acid ester, Eudragit S (poly(methacrylic acid, methyl methacrylate)1:2); Eudragit L100™ (poly(methacrylic acid, methyl methacrylate)1:1); Eudragit L30D™, (poly(methacrylic acid, ethyl acrylate)1:1); and (Eudragit L100-55) (poly(methacrylic acid, ethyl acrylate)1:1) (Eudragit™ L is an anionic polymer synthesized from methacrylic acid and methacrylic acid methyl ester), polymethyl methacrylate blended with acrylic acid and acrylic ester copolymers, alginic acid and alginates such as ammonia alginate, sodium, potassium, magnesium or calcium alginate, vinyl acetate copolymers, polyvinyl acetate 30D (30% dispersion in water), a poly(dimethylaminoethylacrylate) which is a neutral methacrylic ester available from Rohm Pharma (Degusa) under the name “Eudragit E™, a copolymer of methylmethacrylate and ethylacrylate with small portion of trimethylammonioethyl methacrylate chloride (Eudragit RL, Eudragit RS), a copolymer of methylmethacrylate and ethylacrylate (Eudragit NE 30D), Zein, shellac, gums, poloxamer, polysaccharides and/or any combination thereof.

The Outer Coating Layer

In some demonstrative embodiments, the composition may include an outer coating layer (also referred to herein as the “barrier coating layer”). In some embodiments, the outer coating layer may be formulated to prevent or diminish transmission of humidity and/or oxygen into the core, e.g., during the storage and/or throughout the shelf life of the food product.

According to some embodiments, an outer coating layer may comprise at least one polymer having oxygen transmission rate of less than 1000 cc/m2/24 hr, preferably less than 500 cc/m2/24 hr and more preferably, less than 100 cc/m2/24 hr, as measured at standard test conditions (i.e. 73° F. (23° C.) and 0% RH). According to some embodiments, the at least one polymer may have a water vapor transmission rate of less than 400 g/m²/day, preferably, less than 350 g/m²/day, and more preferably, less than 300 g/m²/day.

In some embodiments, the outer coating layer may have an adjusted surface for reducing or preventing the transmission of oxygen and/or humidity into the core of the composition described herein in accordance with some embodiments.

Water Vapor Permeability (WVP) of Films

According to some embodiments, the water vapor permeability is an important property of most outer layer coating films, mainly because of the importance of the role of water in deteriorative reactions.

Water acts as a solvent or carrier and can cause texture degradation, chemical and enzymatic reactions and is thus destructive of oxygen-sensitive liquid natural pharmaceutically or nutritionally active agents. Also the water activity of foods is an important parameter in relation to the shelf-life of the food and food-containing oxygen-sensitive liquid natural pharmaceutically or nutritionally active agents. In low-moisture foods and oxygen-sensitive liquid natural pharmaceutically or nutritionally active agents, low levels of water activity must be maintained to minimize the deteriorative chemical and enzymatic reactions and to prevent the texture degradation. The composition of film forming materials (hydrophilic and hydrophobic character), temperature and relative humidity of the environment affect the water vapor permeability of the films. When considering a suitable barrier in foods containing oxygen-sensitive liquid natural pharmaceutically or nutritionally active agents, the barrier properties of the films may be important parameters.

Polysaccharide films and coatings may generally be good barriers against oxygen and carbon dioxide and have good mechanical properties but their barrier property against water vapor is poor because of the their hydrophilic character.

One way to achieve a better water vapor barrier may be to add an extra hydrophobic component, e.g. a lipid (waxes, fatty acids), in the film and produce a composite film. Here the lipid component serves as the barrier against water vapor. By adding lipid, the hydrophobicity of the film is increased and as a result of this case, water vapor barrier property of the film increases.

Water Vapor Permeability of a film is a constant that should be independent of the driving force on the water vapor transmission. When a film is under different water vapor pressure gradients (at the same temperature), the flow of water vapor through the film differs, but their calculated permeability should be the same. This behavior does not happen with hydrophilic films where water molecules interact with polar groups in the film structure causing plasticization or swelling.

Another assumption inherent to the calculation of permeability is its independence from film thickness. This assumption may not be true for hydrophilic films and because of that, experimentally determined water vapor permeability of many films applied only to the specific water vapor gradients used during testing and for the specific thickness of the tested specimens, use of the terms “Effective Permeability” or “Apparent Permeability” may be appropriate.

Moisture transport mechanism through a composite depends upon the material and environmental conditions. Permeability has two different features in case of composites. First, in non-porous membranes, permeation can occur by solution and diffusion, and the other, simultaneous permeation through open pores is possible in porous membrane.

There are various methods of measuring permeability. Weight loss measurements are of importance to determine permeability characteristics. Water vapor permeability may be determined by direct weighing because, despite its inherent problems, mainly related to water properties such as high solubility and cluster formation within the polymer and tendency to plasticize the polymer matrix, it can be a straightforward and relatively reliable method. The major disadvantage of this method resides in its weakness to provide information for a kinetic profile when such a response is required.

Another measurement method is based on the standard described in ASTM E96-80 (standard test method procedure for water vapor permeability). According to this method, water vapor permeability is determined gravimetrically and generally the applied procedures are nearly the same in many research papers that are related with this purpose. In this procedure firstly, the test film is sealed to a glass permeation cell which contain anhydrous calcium chloride (CaCl₂), or silica gel (Relative vapor pressure; RVP=0) and then the cell is placed in the desiccators maintained at specific relative humidity and temperature (generally 300 C, 22% RH) with magnesium nitrate or potassium acetate. Permeation cells are continuously weighed and recorded, and the water vapor that transferred through the film and absorbed by the desiccant are determined by measuring the weight gain. Changes in weight of the cell were plotted as a function of time. When the relationship between weight gain (Δw) and time (Δt) is linear, the slope of the plot is used to calculate the water vapor transmission rate (WVTR) and water vapor permeability (WVP). Slope is calculated by linear regression and correlation coefficient (r2>>0.99).

The WVTR is calculated from the slope (Δw/Δt) of the straight line divided

by the test area (A), (g s−1 m−2):

WVTR=Δw/(Δt·A)(g·m−2·s−1)

Where
Δw/Δt=transfer rate, amount of moisture loss per unit of time (g·s−1)
A=area exposed to moisture transfer (m²)
The WVP (kg Pa−1 s−1 m−1) is calculated as:

WVP=[WVTR/S(R1−R2)]·d

Where S=saturation vapor pressure (Pa) of water at test temperature,
R1=RVP (relative vapor pressure) in the desiccator,
R2=RVP in the permeation cell, and
d=film thickness (m).

In some embodiments, at least three replicates of each film should be tested for WVP and all films should be equilibrated with specific RH before permeability determination.

The water vapor permeability can also be calculated from the WVTR as follows:

P=WVTR·L/Δp(g/m̂2·s·Pa)
L=film thickness (m)
Δp=water vapor pressure gradient between the two sides of the film (Pa)
P=film permeability (g·m−2·s−1Pa−1)

The rate of permeation is generally expressed by the permeability (P) rather than by a diffusion coefficient (D) and the solubility (S) of the penetrant in the film. When there is no interaction between the water vapor and film, these laws can apply for homogeneous materials. Then, permeability follows a solution-diffusion model as:

P=D·S

Where D is the diffusion coefficient and the S is the slope of the sorption isotherm and is constant for the linear sorption isotherm.

The diffusion coefficient describes the movement of permeant molecule through a polymer, and thus represents a kinetic property of the polymer-permeant system.

As a result of the hydrophilic characteristics of polysaccharide films, the water vapor permeability of films is related to their thickness. The permeability values increase with the increasing thickness of the films.

Thickness of films and the molecular weight (MW) of the film forming polymers may also affect both water vapor permeability (WVP) and oxygen permeability (OP) of the films.

Oxygen Transmission Determination (OTR)

Oxygen transmission rate is the steady-state rate at which oxygen gas permeates through a film at specified conditions of temperature and relative humidity. Values are expressed in cc/100 in2/24hr in US standard units and cc/m²/24hr in metric (or SI) units.

Gas permeability, especially oxygen permeability, of the polymer may indicate the protective function of the polymer as a barrier against oxygen transmission. Such polymers which demonstrate low oxygen permeability may be used in the outer coating layer. For the purpose of the composition as discussed herein, the relevant gas for improved stability of the oxygen-sensitive liquid natural pharmaceutically or nutritionally active agents is oxygen. The viability of oxygen-sensitive liquid natural pharmaceutically or nutritionally active agents may be significantly reduced upon exposing to oxygen. Therefore, for providing long term stability and receiving an extended shelf life for oxygen-sensitive liquid natural pharmaceutically or nutritionally active agents, the outer coating layer should provide a significant oxygen barrier.

The gas permeability, q, (ml/m²/day/atm) (DIN 53380) is defined as the volume of a gas converted to 0° C. and 760 torr which permeates 1 m² of the film to be tested within one day at a specific temperature and pressure gradient. It may therefore be calculated according to the following formula: q={To·Pu/[Po·T·A(Pb−Pu)]}·24·Q·(Δx/Δt)·10⁴
Po=normal pressure in atm
To=normal temperature in K
T=experimental temperature in K
A=sample area in m²
T=time interval in hrs between two measurements
Pb=atmospheric pressure in atm
Pu=pressure in test chamber between sample and mercury thread
Q=cross section of capillaries in cm
Δx/Δt=sink rate of the mercury thread in cm/hr

The following table shows Oxygen Transmission rate (OTR) and Water vapor Transmission rate (WVTR) of some example water soluble polymers.

| | Oxygen | Water vapor |
|---|---|---|
| Film Forming | Transmission rate, | Transmission rate, |
| Polymer | Cm³/m²/atm O₂ day | g/m²/day |
| HPC, Klucel EF | Medium | Low |
| | 776 | 126 |
| CMC, Aqualon or | Low | Low |
| Blanose 7L | 18 | 228 |
| HEC, Natrosol 250L | Low | Medium |
| | 33 | 360 |
| HPMC 5 cps | High | High |
| | 3180 | 420 |

Non-limiting examples of outer layer coating polymer include water-soluble, hydrophilic polymers, such as, for example, polyvinyl alcohol (PVA), Povidone (PVP: polyvinyl pyrrolidone), Copovidone (copolymer of vinyl pyrrolidone and vinyl acetate), Kollicoat Protect (BASF) which is a mixture of Kollicoat IR (a polyvinyl alcohol (PVA)-polyethylene glycol (PEG) graft copolymer) and polyvinyl alcohol (PVA), Opadry AMB (Colorcon) which is a mixture based on PVA, Aquarius MG which is a cellulosic-based polymer containing natural wax, lecithin, xanthan gum and talc, low molecular weight HPC (hydroxypropyl cellulose), starch, gelatin, low molecular weight carboxy methyl cellulose such as 7LF, 7L2P, Na-carboxy methyl cellulose, or a mixture/mixtures thereof. In some embodiments, mixture(s) of water soluble polymers with insoluble agents such as waxes, fats, fatty acids, and/or the like, may be utilized.

In some preferred embodiments, the outer coating polymer(s) are carboxy methyl cellulose such as 7LF or 7L2P, polyvinyl alcohol, Kollicoat Protect (BASF) which is a mixture of Kollicoat IR (a polyvinyl alcohol (PVA)-polyethylene glycol (PEG) graft copolymer) and polyvinyl alcohol (PVA) and silicon dioxide, Opadry AMB (Colorcon) which is a mixture based on PVA, and Aquarius MG which is a cellulosic-based polymer containing natural wax. Theses polymers may provide superior barrier properties against water vapor/humidity and/or oxygen penetration into the core or granules.

According to some demonstrative embodiments, the outer coating layer may include one or more other excipients, such as, by way of non-limiting example, at least one plasticizer.

The Enteric Coating

According to some demonstrative embodiments, the composition described herein may optionally include an enteric coating layer. In some embodiments, the enteric coating layer may provide protection for the composition from destructive parameters such as low pHs and enzymes, upon digestion and passage through the gastrointestinal (GI) tract. According to some embodiments, the enteric coating may provide a delayed release profile for the composition, e.g., upon digestion.

According to some embodiments, the enteric coating layer may include an enteric polymer selected from, but not limited to, the group including: phthalate derivatives such as acid phthalate of carbohydrates, amylose acetate phthalate, cellulose acetate phthalate (CAP), other cellulose ester phthalates, cellulose ether phthalates, hydroxypropylcellulose phthalate (HPCP), hydroxypropylethylcellulose phthalate (HPECP), hydroxyproplymethylcellulose phthalate (HPMCP), hydroxyproplymethylcellulose acetate succinate (HPMCAS), methylcellulose phthalate (MCP), polyvinyl acetate phthalate (PVAcP), polyvinyl acetate hydrogen phthalate, sodium CAP, starch acid phthalate, cellulose acetate trimellitate (CAT), styrene-maleic acid dibutyl phthalate copolymer, styrene-maleic acid/polyvinylacetate phthalate copolymer, styrene and maleic acid copolymers, polyacrylic acid derivatives such as acrylic acid and acrylic ester copolymers, polymethacrylic acid and esters thereof, polyacrylic and methacrylic acid copolymers, and vinyl acetate and crotonic acid copolymers. In some embodiments, pH-sensitive polymers include shellac, phthalate derivatives, CAT, HPMCAS, polyacrylic acid derivatives, particularly copolymers comprising acrylic acid and at least one acrylic acid ester, Eudragit™ S (poly(methacrylic acid, methyl methacrylate)1:2); Eudragit L100™ (poly(methacrylic acid, methyl methacrylate)1:1); Eudragit L30D™, (poly(methacrylic acid, ethyl acrylate)1:1); and (Eudragit L100-55) (poly(methacrylic acid, ethyl acrylate)1:1) (Eudragit™ L is an anionic polymer synthesized from methacrylic acid and methacrylic acid methyl ester), polymethyl methacrylate blended with acrylic acid and acrylic ester copolymers, alginic acid and alginates, ammonia alginate, sodium, potassium, magnesium or calcium alginate, vinyl acetate copolymers, polyvinyl acetate 30D (30% dispersion in water), a poly(dimethylaminoethylacrylate) “Eudragit E™, a copolymer of methylmethacrylate and ethylacrylate with small portion of trimethylammonioethyl methacrylate chloride (Eudragit RL, Eudragit RS), a copolymer of methylmethacrylate and ethylacrylate (Eudragit NE 30D), Zein, shellac, gums, poloxamer, polysaccharides.

In some demonstrative embodiments of the present invention there is provided a process and method for stabilizing at least one oxygen-sensitive liquid natural pharmaceutically or nutritionally active agents to be used as a supplement, food additive and/or as a supplement which may be added into a food product.

In some demonstrative embodiments, the process and/or method described herein may provide for a substantially humidity resistant oxygen-sensitive liquid natural pharmaceutically or nutritionally active agent, and accordingly enable high stability and/or prolonged shelf life for a food product at ambient temperature, wherein the composition yielded by the process or method described herein is stable throughout heating step(s) needed during the preparation of many food products, e.g., as described in detail above.

According to some demonstrative embodiments, the method may include one or more ways to prepare a core of a composition, which includes at least one oxygen-sensitive liquid natural pharmaceutically or nutritionally active agent optionally with one or more excipients. The method may further include coating the core with one or more coating layers.

Preparation of the Core

According to some demonstrative embodiments, the method may include absorbing and/or adsorbing the at least one oxygen-sensitive liquid natural pharmaceutically or nutritionally active agents onto a core. According to some embodiments, the at least one oxygen-sensitive liquid natural pharmaceutically or nutritionally active agent may be absorbed or adsorbed onto the core in the form of a suspension (wet or dry) or solid dispersion or solution, or may optionally be absorbed or adsorbed directly.

According to some embodiments, if an emulsion is used, the emulsion may be prepared by dispersing the oxygen-sensitive liquid natural pharmaceutically or nutritionally active agent and an oxygen scavenger in purified degassed water, e.g., using an emulsifier and/or a homogenizer. The resulting emulsion may be sprayed onto an absorbent, for example, an absorbent which was preheated at 40° C. The spraying may be done under an inert gas to obtain a core comprising the at least one oxygen-sensitive liquid natural pharmaceutically or nutritionally active agent which is absorbed by the absorbent which may be, for example, a solidified oil.

According to other demonstrative embodiments the method of the present invention may include preparing a liquid mixture of an at least one oxygen-sensitive liquid natural pharmaceutically or nutritionally active agent, at least one of a stabilizer, an antioxidant (“oxygen scavenger”), a filler, a plasticizer, a surfactant (also referred to as a “surface free energy-lowering agent”), a binder, and optionally a hydrophobic solid fat or fatty acid is in a melt state. According to these embodiments, the method may include spraying the liquid mixture onto a substrate to obtain a solid fatty matrix particle. The solid fatty matrix particle embeds the substrate and oxygen-sensitive liquid natural pharmaceutically or nutritionally active agent. Additionally or alternatively, spraying the liquid mixture onto the substrate may form a film around the substrate/core. According to these demonstrative embodiments, the method may include spraying while using an inert gas and/or under a non-reactive atmosphere.

Although the mixture may optionally comprise an emulsion, according to preferred embodiments the mixture does not comprise an emulsion and in fact does not feature an emulsion. Optionally, the mixture consists essentially of the oxygen-sensitive liquid natural pharmaceutically or nutritionally active agent, without any added material. Alternatively, the mixture features the oxygen-sensitive liquid natural pharmaceutically or nutritionally active agent in the form of a suspension, whether a liquid or dry suspension. Also alternatively, the mixture features the oxygen-sensitive liquid natural pharmaceutically or nutritionally active agent in a solid dispersion, for example and without limitation a melt. Optionally and more preferably, the melt comprises stearic acid and/or a PEG based polymer, which may optionally comprise a PEG based co-polymer, optionally without a substrate for absorbing the melt.

According to some embodiments, if the core is made in the form of granules, the granules may be prepared using a fluidized bed technology, such as by way of non-limiting example: Glatt or turbo jet, Glatt or an Innojet coater/granulator, a Huttlin coater/granulator, a Granulex, and/or the like.

According to some demonstrative embodiments, the total amount of the at least one oxygen-sensitive liquid natural pharmaceutically or nutritionally active agent in the mixture is from about 10% to about 90% by weight of the core.

Coating of the Core

In some demonstrative embodiments, the core may be coated by a first coating layer which may include at least one hydrophobic solid fat and/or fatty acid as described hereinabove.

According to some embodiments, the method may include using the at least one hydrophobic solid fat and/or fatty acid to form a stable hydrophobic film or matrix which may embed to the core or may form a film around the core to obtain hydrophobic solid fat coated core.

In some demonstrative embodiments, the method may include coating the hydrophobic solid fat coated core with an intermediate coating layer to obtain intermediate layer coated core. According to some embodiments, the intermediate coating layer may include an aqueous solution of 0.1% and have a surface tension lower than 60 mN/m as measured at 25° C. Preferably, the surface tension is lower than 50 mN/m, more preferably lower than 45 mN/m.

According to some demonstrative embodiments, the method may include coating the intermediate layer coated core with an outer coating layer to obtain stabilized oxygen-sensitive liquid natural pharmaceutically or nutritionally active agents (as micro-particles). According to some embodiments, the outer coating layer may include a polymer having oxygen transmission rate of less than 1000 cc/m²/24 hr, preferably less than 500 cc/m²/24 hr, more preferably less than 100 cc/m²/24 hr, as measured at standard test conditions (i.e. 73° F./23° C. and 0% RH). According to some embodiments, the polymer may have a water vapor transmission rate of less than 400 g/m²/day, preferably, less than 350 g/m²/day, more preferably, less than 300 g/m²/day.

In some demonstrative embodiments, the method may optionally include coating the resulting micro-particles with an enteric polymer which may provide protection from destructive parameters such as low pHs and enzymes upon digestion and passage through the GI tract.

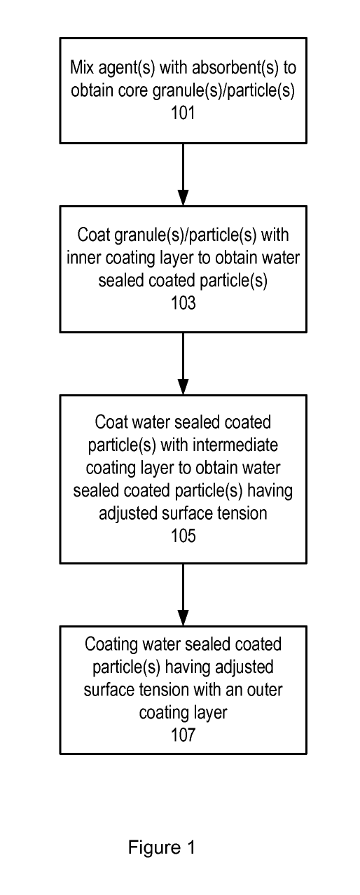

As illustrated in FIG. 1, according to some embodiments of the present invention, the process of manufacturing a composition as described herein, i.e., micro encapsulated oxygen-sensitive liquid natural pharmaceutically or nutritionally active agents, may comprise:
1. mixing oxygen-sensitive liquid natural pharmaceutically or nutritionally active agents with at least one absorbent (101) thereby obtaining a core granule or particle;
2. coating particles of said core granule with an inner coating layer (103) comprising a hydrophobic solid fat or fatty acid preventing or reducing the penetration of water or humidity into said core, thereby obtaining water sealed coated particles;
3. coating said water sealed coated particles with an intermediate coating layer for adjusting surface tension (105) for further coating with outer coating layer thereby obtaining water sealed coated particles having an adjusted surface tension; and
4. coating said water sealed coated particles having an adjusted surface tension with an outer coating layer (107) for reducing transmission of oxygen and humidity into the core thereby obtaining a multiple-layered particle containing oxygen-sensitive liquid natural pharmaceutically or nutritionally active agents showing superior stability against oxygen and humidity on storage duration and during the shelf life thus showing higher vitality.

According to other embodiments of the present invention, the process of manufacturing the composition of the present invention may comprise:
preparing an emulsion of oxygen-sensitive liquid natural pharmaceutically or nutritionally active agents in water using an appropriate surfactant; According to some embodiments, the oxygen-sensitive liquid natural pharmaceutically or nutritionally active agents in water may optionally be in a non-emulsion form, e.g., in a suspension form, thus obviating the need to use the surfactant;
spraying the resulting emulsion/suspension onto at least one absorbent thereby obtaining a core granule or particle;
coating particles of said core granule with an inner coating layer comprising a hydrophobic solid fat or fatty acid for preventing or reducing the penetration of water or humidity into said core to obtain water sealed coated particles;
coating said water sealed coated particles with an intermediate coating layer for adjusting surface tension for further coating with outer coating layer thereby obtaining water sealed coated particles having an adjusted surface tension; and
coating said water sealed coated particles having an adjusted surface tension with an outer coating layer for reducing transmission of oxygen and humidity into the core to obtain a multiple-layered particle containing oxygen-sensitive liquid natural pharmaceutically or nutritionally active agents showing superior stability against oxygen and humidity on storage duration and during the shelf life and thus showing higher vitality.
Optionally coating the resulting particle with an enteric coating.

In some embodiments, the process of manufacturing the composition described hereinabove may comprise:
preparing a mixture of oxygen-sensitive liquid natural pharmaceutically or nutritionally active agents with melt of at least one solid fat or fatty acid to obtain a liquid mixture, with or without being in the form of an emulsion;
spraying the resulting liquid mixture onto at least one absorbent to obtain a core granule or particle;
coating particles of said core granule with an inner coating layer comprising a hydrophobic solid fat or fatty acid preventing or reducing the penetration of water or humidity into said core to obtain water sealed coated particles;
coating said water sealed coated particles are with an intermediate coating layer for adjusting surface tension for further coating with an outer coating
layer to obtain water sealed coated particles having an adjusted surface
tension; and
coating said water sealed coated particles having an adjusted surface tension with an outer coating layer for reducing transmission of oxygen and humidity into the core to obtain a multiple-layered particle containing oxygen-sensitive liquid natural pharmaceutically or nutritionally active agents showing superior stability against oxygen and humidity on storage duration and during the shelf life thus showing higher vitality.

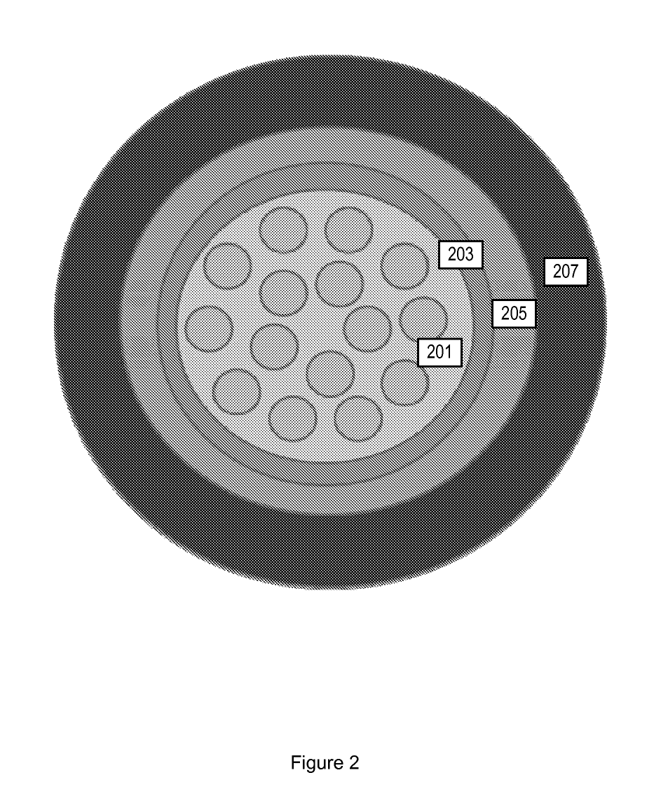

FIG. 2 illustrates a schema of a multiple-layered microencapsulated an oxygen-sensitive liquid natural pharmaceutically or nutritionally active agent such as fish oil or omega 3 fatty acids according to one embodiment of the present invention. The inner core 201 comprises a porous absorbent saturated by an oxygen-sensitive liquid natural pharmaceutically or nutritionally active agent. A first fat coating layer 203 which is the most inner coating layer comprises at least one hydrophobic solid fat or fatty acid having a melting point lower than 50° C. and higher than 25° C., in some embodiments lower than 45° C. and higher than 30° C. and in further embodiments lower than 40° C. and higher than 35° C., forming a stable hydrophobic film layer around the inner core 201. The first fat coating layer 203 is surrounded by the intermediate layer 205, whose aqueous solution of 0.1% has a surface tension lower than 60 mN/m. The outermost layer 207 comprises a polymer having oxygen transmission rate of less than 1000 cc/m2/24 hr.

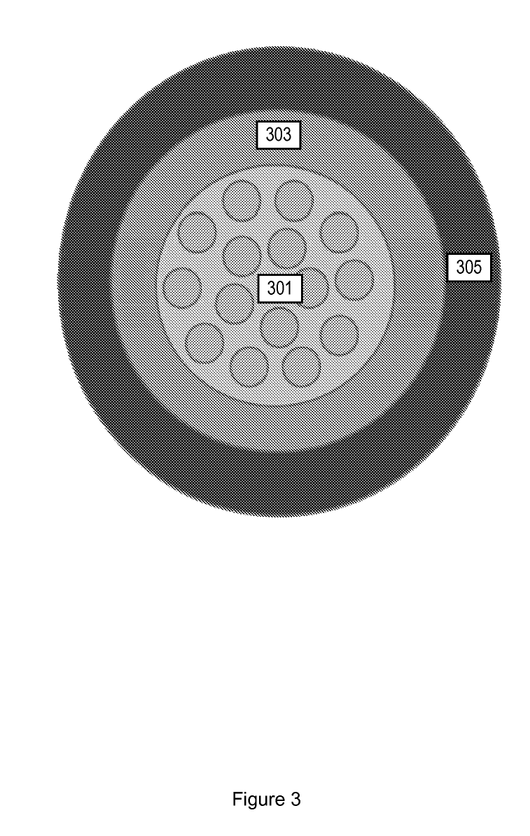

FIG. 3 illustrates a schema of a multiple-layered microencapsulated oxygen-sensitive liquid natural pharmaceutically or nutritionally active agent such as fish oil or omega 3 fatty acids according to one embodiment. An inner core 301 comprises a porous absorbent saturated and coated by a first coating layer comprising at least one hydrophobic solid fat or fatty acid having a melting point lower than 50° C. and higher than 25° C. and oxygen-sensitive liquid natural pharmaceutically or nutritionally active agent.

Surrounding the inner core 301 is the intermediate layer 303, whose aqueous solution of 0.1% has a surface tension lower than 60 mN/m. The outermost layer 305 comprises a polymer having oxygen transmission rate of less than 1000 cc/m²/24 hr.

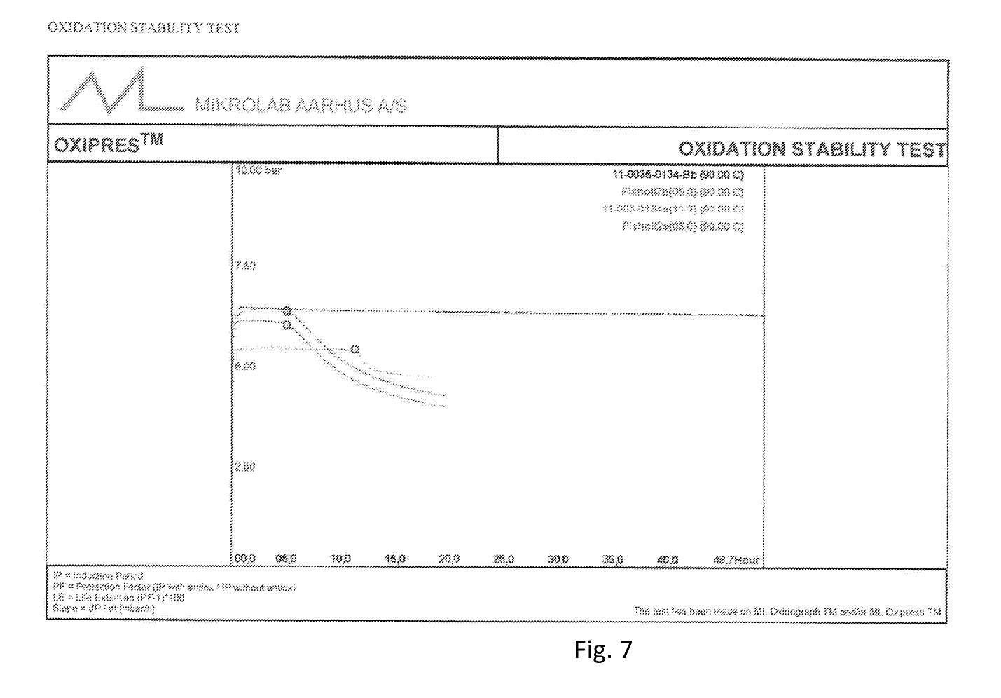

FIG. 7 demonstrates an accelerated stability test carried out using ML OXIPRES™ test method. The test shows the capability to withstand oxidation at elevated temperature (90° C.) and under an initial oxygen pressure of 5 bar of a microencapsulated omega 3 oil prepared according to some embodiments described in Example 1 below, of omega 3 absorbed by the absorbent and as compared to omega 3 oil.

Microencapsulation

According to at least some embodiments there is provided microencapsulated omega 3 oil, comprising omega 3 oil encapsulated in one or more materials. Microencapsulated omega 3 oil may optionally be used in place of the core embodiments described herein. Also optionally, microencapsulated omega 3 oil may lack one or more of the additional layers described herein, or may even lack all such layers. Optionally and alternatively, microencapsulated omega 3 oil may feature only one layer, such as only an enteric coating for example or only the previously described barrier coating layer comprising a polymer having oxygen transmission rate of less than 1000 cc/m2/24 hr measured at standard test conditions and a water vapor transmission rate of less than 400 g/m²/day.

According to at least some embodiments, microencapsulated omega 3 oil may optionally be prepared according to one or more of dry encapsulation, melting or extrusion. If extrusion is used, preferably an oil or other lubricant is used in the process. Extrusion may also optionally comprise spheronisation and may also optionally be performed as cold extrusion.

Microencapsulation may optionally be performed with one or more encapsulating materials, including but not limited to waxes, thickeners and binders, or combinations thereof. Non-limiting examples of suitable waxes include stearic acid. Non-limiting examples of thickeners include fumed silica (such as Aerosil for example), microcrystalline cellulose (such as Avicel for example) and starch (such as starch 1500 for example). Preferred combinations of encapsulating materials for microencapsulation include but are not limited to microcrystalline cellulose and fumed silica; microcrystalline cellulose, stearic acid and fumed silica; fumed silica and stearic acid; or fumed silica, stearic acid and starch. Of course use of single encapsulating materials or other combinations of encapsulating materials are encompassed within various embodiments of the present invention.

For dry encapsulation, preferably the dry encapsulating materials are mixed together first, followed by mixing with omega 3 oil. Optionally however one or more dry encapsulating materials may be initially mixed with omega 3 oil, followed by mixing with one or more additional encapsulating materials. The initial mixing of the materials with omega 3 oil may optionally be preceded by dry mixing of a plurality of dry encapsulating materials. Such dry mixed encapsulating materials may optionally be heated before being mixed with omega 3 oil. Non-limiting examples of suitable encapsulating material combinations for dry encapsulation include microcrystalline cellulose and fumed silica; fumed silica and stearic acid; or microcrystalline cellulose, stearic acid and fumed silica. Fumed silica is optionally used as a single encapsulating material for dry encapsulation.

For melt encapsulation, optionally dry mixing of one or more encapsulation materials is performed initially. One or more encapsulation materials (whether pre-mixed or not) is then mixed with omega 3. A melt material is then melted and mixed with the omega 3 mixture. The melt material is preferably in melted form (for example, optionally after heating) and may optionally comprise a solvent such as ethanol for example.

Non-limiting examples of suitable encapsulating material combinations for melt encapsulation include microcrystalline cellulose, stearic acid and fumed silica; or stearic acid and fumed silica.

For extrusion, optionally a paste is formed, containing omega 3 oil, and is then extruded to form pellets. The paste may be formed with optional dry mixing of one or more encapsulation materials. One or more encapsulation materials (whether pre-mixed or not) is then mixed with omega 3, optionally with heating. Non-limiting examples of suitable encapsulating material combinations for extrusion encapsulation include fumed silica, stearic acid and starch.

Detailed examples of the formulations and methods of preparation for microencapsulation, and testing results, are given in Examples 4-13 below.

### EXAMPLE 1

800 g of Vivapur 12 (microcrystalline cellulose-MCC) was used as absorbent. An emulsion was prepared based on the following composition:
Omega 3 oil=150 g
Water=350 g
Tween=5 g
Tocopherol=0.15 g

MCC was first loaded into Innojet-IEV2.5 V2, and heated at 40° C. for 30 minutes while fluidizing prior to spraying the emulsion. The emulsion was then sprayed on microcrystalline cellulose using nitrogen as an inert gas.

After spraying about 100 g of emulsion, 20 g of Aerosil 200 was added and emulsion was sprayed again. After spraying 228.9 g of emulsion, an additional 10 g Aerosil 200 was added. The process was stopped and the container of Innojet-IEV2.5 V2 was changed to IPC 3 (IPC 1 was filled up until the upper edge of the container). 838 g of omega 3 oil-absorbed MCC were re-loaded and spraying of emulsion was renewed. After 338 g of emulsion, an additional 5 g Aerosil 200 was added. The process finished, yielding 923 g. The inlet temperature was continuously kept at 40° C.

400 g of Omega 3 absorbed-MCC was then loaded into an Innojet coater and lauric acid (which was previously melted at 60° C.) was sprayed using nitrogen as an inert gas. The process was stop after reaching a weight gain of about 125 g. Then Na-alginate solution (2% w/w in purified water) was sprayed onto the above resulting particles to result in Na-alginate coated particles. Finally, the aqueous solution (5% w/w) of Na-carboxy methyl cellulose and polyethylene glycol (PEG 400, 25% w/w) was sprayed onto the above resulting Na-alginate coated particles to reach weight gain of 40% of Na-carboxymethyl cellulose. The final product was dried and kept in a double sealed polyethylene bag with a proper desiccant in a refrigerator.

Oxidation Test

An oxidation test method was used to evaluate the capability of the final product resulted from Example 1 to withstand oxidation during the shelf life. For this purpose, an accelerated oxidation test method was used. The method was based on OXIPRES™ Method. The ML OXIPRES™ (MIKROLAB AARHUS A/S Denmark) is a modification of the bomb method, which is based on oxidation with oxygen under pressure. The test is accelerated when carried out at elevated pressure and temperature. The consumption of oxygen, which means that oxidation process occurs, is determined by the pressure drop in the pressure vessel during the experiment. The time at which the oxygen pressure started to drop is called Induction Period. A longer Induction Period means that the protection against oxidation process is higher, indicating that the contents of the microcapsules, prepared according to some embodiments described hereinabove, are better protected towards oxidation process.

The capability of microencapsulated omega 3 oil from Example 1 and omega 3 absorbed or adsorbed by the absorbent as compared to omega 3 oil to withstand oxidation was evaluated using ML OXIPRES™ test method at elevated temperature and under an initial oxygen pressure of 5 bar. Samples of 5 grams for each pattern were used for the test. The results, shown by Induction Period, are summarized in Table 1 and FIG. 6.

Results

TABLE 1
Induction Periods of different samples prepared according to an
exemplary embodiment described hereinabove as compared to
omega 3 as-is.

| | | | Estimated |
|---|---|---|---|
| | Test | Induction | shelf |
| | Temperature | Period | life |
| Sample | (° C.) | (Hours) | (days) |
| *Microencapsulated | 90 | >50 | 266.7 |
| omega 3 oil | | | |
| Omega 3 | 90 | 11.2 | 59.7 |
| absorbed | | | |
| by the absorbent | | | |
| Omega 3 oil | 90 | 5.0 | 26.7 |
| Omega 3 oil | 90 | 5.0 | 26.7 |

### EXAMPLE 2

### Non-Emulsion-Based Microencapsulation Process of Omega 3 and Fish Oil

Vivapur 105 (microcrystalline cellulose-MCC) (800 g) was mixed with concentrated Eicosapentaenoic acid (EPA 88%) of omega 3 oil for about 1 hour at room temperature.

The resulting mixture was then loaded into Innojet-IEV2.5 V2 and aerosil (25 g) was added. Poloxamer 188 (a triblock copolymer composed of a central hydrophobic chain of polyoxypropylene (poly(propylene oxide)) flanked by two hydrophilic chains of polyoxyethylene (poly(ethylene oxide)) (300 g) was melted and sprayed onto the mixture. The resulting mixture coated by poloxamer was discharged and the container of Innojet-IEV2.5 V2 10 was changed to IPC 3 (IPC 1 was filled up until the upper edge of the container). 300 g of the resulting mixture coated by poloxamer were re-loaded and an aqueous solution (5% w/w) of Na-carboxy methyl cellulose (CMC) and polyethylene glycol (PEG 400) (CMC:PEG 9:1) was sprayed. The inlet temperature was continuously kept at 40° C.

The process was stopped after reaching a weight gain of about 10% of Na-carboxymethyl cellulose/PEG.

Then Na-alginate solution (2% w/w in purified water) was sprayed onto 290 g of the above resulting particles to result in Na-alginate coated particles having 11% (w/w) Na-alginate. Then finally an additional 7.7% (w/w) of Na-carboxy methyl cellulose (CMC) and polyethylene glycol (PEG 400) (CMC:PEG 9:1) was added to 301 g of the above particles to obtain the following composition:

| Amount | | Amount |
|---|---|---|
| [g] | Substance | [abs %] |
| 70.97 | MCC | 21.77 |
| | Vivapur 106 | |
| 57.13 | EPA oil | 17.52 |
| 8.87 | Aerosil | 2.72 |
| 106.45 | Poloxamer | 32.65 |
| | 189 | |
| 24.34 | CMC/PEG | 7.47 |
| | 400 (90:10) | |
| 33.24 | Na-Alginat | 10.20 |
| 25.00 | CMC/PEG | 7.67 |
| | 400 (90:10) | |
| 326.00 | | |

The final product was dried and kept in a double sealed polyethylene bag with a proper desiccant in a refrigerator.

### EXAMPLE 3

200 g of Vivapur 12 (microcrystalline cellulose-MCC) was first loaded into Innojet-IEV2.5 V2, and aerosil (4 g) was added. Then a mixture of fish oil (96.9 g) in fused stearic acid (115.1 g), which was previously melted at 70° C., was sprayed on microcrystalline cellulose to obtain coated particles. Then Poloxamer 188 (a triblock copolymer composed of a central hydrophobic chain of polyoxypropylene (poly(propylene oxide)) flanked by two hydrophilic chains of polyoxyethylene (poly(ethylene oxide)) (74 g) was melted and sprayed onto 367 g of the above coated mixture. Then an aqueous solution (5% w/w) of Na-carboxy methyl cellulose (CMC) and polyethylene glycol (PEG 400) (CMC:PEG 9:1), was sprayed onto 300 g of the resulting mixture coated by poloxamer. The inlet temperature was continuously kept at 40° C.

The process was stopped after reaching a weight gain of about 20% of Na-carboxymethyl cellulose/PEG to have the following composition:

| Amount | | Amount |
|---|---|---|
| [g] | Substance | [abs %] |
| 120.03 | MCC | 33.34 |
| | Vivapur 12 | |
| 2.40 | Aerosil | 0.67 |
| 58.15 | Fish oil | 16.15 |
| 69.08 | Stearic acid | 19.19 |
| 50.34 | Poloxamer | 13.98 |
| | 188 | |
| 60.00 | CMC/PEG | 16.67 |
| | 400 (90:10) | |
| 360.00 | | |

The final product was dried and kept in a double sealed polyethylene bag with a proper desiccant in a refrigerator.

### EXAMPLE 4

The microencapsulation of omega 3 oil compositions in Table 4 below was prepared according to the following dry microencapsulation procedure: the microcrystalline cellulose and Aerosil were mixed together by mechanical stirrer at room temperature to obtain a homogenized blend. The mixture was heated to 50° C. The omega 3 oil was added and mixed with the powder to obtain a granule. The granule remained at room temperature for 1-24 hours.

TABLE 4

| | Formulation No. | | | | | | |
|---|---|---|---|---|---|---|---|
| | 1-1 | 1-2 | 1-3 | 1-4 | 1-5 | 1-6 | 1-7 |
| Ingredients | (%) w/w | | | | | | |
| Omega 3 oil* | 50.0 | 50.0 | 50.0 | 50.0 | 60.0 | 60.0 | 70.0 |
| Microcrystalline | 47.5 | 45.0 | 40.0 | 42.5 | 32.0 | 36.0 | 27.0 |
| cellulose** | | | | | | | |
| Aerosil | 2.5 | 5.0 | 10.0 | 7.5 | 8.0 | 4.0 | 3.0 |
| Total | 100 | 100 | 100 | 100 | 100 | 100 | 100 |

*the ratio of EPA:DHA is 2:1
**Avicel PH-102

### EXAMPLE 5

The microencapsulation of omega 3 oil compositions in Table 5 below was prepared according to the following dry microencapsulation procedure: the microcrystalline cellulose, Aerosil and Stearic acid were mixed together by mechanical stirrer at room temperature to obtain a homogenized blend. The powder blend was heated to 70° C. The omega 3 oil was added and mixed with the powder to obtain a granule. The granule remained at room temperature for 1-24 hours.

TABLE 5

| | Formulation No. | | | | |
|---|---|---|---|---|---|
| | 2-1 | 2-2 | 2-3 | 2-4 | 2-5 |
| Ingredients | (%)w/w | | | | |
| Omega 3 oil* | 60.0 | 60.0 | 50.0 | 50.0 | 50.0 |
| Microcrystalline cellulose** | 19.2 | 12.8 | 32.0 | 28.0 | 16.0 |
| Aerosil | 4.8 | 3.2 | 8.0 | 7.0 | 4.0 |
| Stearic acid | 16.0 | 24.0 | 10.0 | 15.0 | 30.0 |
| Total | 100 | 100 | 100 | 100 | 100 |

*The ratio of EPA:DHA is 2:1
**Avicel PH-102

### EXAMPLE 6

The microencapsulation of omega 3 oil compositions in Table 6 below was prepared according to the following wet microencapsulation procedure: the microcrystalline cellulose and Aerosil were mixed together by mechanical stirrer at room temperature to obtain a homogenized blend. The omega 3 oil was added and mixed with the blend. The Stearic acid was melted at 70° C. and mixed with an ethanol by the weight ratio of 1:1. The melted solution of stearic acid with ethanol was added to the omega 3 powder blend to obtain a wet granule. The wet granule was drying by vacuum oven at 30° C. for at least 1 hour.

TABLE 6

Formulation No.

| | |
|---|---|
| 3-1 | 3-2 |

| | |
|---|---|
| Ingredients | (%) |

| | | |
|---|---|---|
| Omega 3 oil* | 60.0 | 60.0 |
| Microcrystalline cellulose** | 19.2 | 12.8 |
| Aerosil | 4.8 | 3.2 |
| Stearic acid | 16.0 | 24.0 |
| Total | 100 | 100 |

*the ratio of EPA:DHA is 2:1
**Avicel PH-102

### EXAMPLE 7

The granules of omega 3 oil compositions in Table 7 below were prepared according to the following dry microencapsulation procedure: The omega 3 oil was added to an Aerosil powder during the mixing by mechanical stirrer at room temperature. The granule remained at room temperature for 1-24 hours.

TABLE 7

| | Formulation No. | | | | |
|---|---|---|---|---|---|
| | 4-1 | 4-2 | 4-3 | 4-4 | 4-5 |
| Ingredients | (%) w/w | | | | |
| Omega 3 oil* | 80.0 | 85.0 | 90.0 | 80.0 | 80.0 |
| Aerosil | 20.0 | 15.0 | 10.0 | 10.0 | 20.0 |
| Total | 100 | 100 | 100 | 100 | 100 |

*the ratio of EPA:DHA is 2:1

### EXAMPLE 8

The microencapsulation of omega 3 oil compositions in Table 8 below was prepared according to the following wet microencapsulation procedure. Stearic acid was melted at 70° C. and mixed with ethanol by the weight ratio of 1:1. Aerosil was mixed together with omega 3 oil by mechanical stirrer at room temperature to obtain a granule. The granule was added to the Stearic melt solution with ethanol in continuous mixing process. The wet granule was dried by vacuum oven at 30° C. for at least 1 hour to obtain an omega 3 microgranule.

TABLE 8

| | Formulation No. | | | | | |
|---|---|---|---|---|---|---|
| | 5-1 | 5-2 | 5-3 | 5-4 | 5-5 | 5-6 |
| Ingredients | (%) w/w | | | | | |
| Omega 3 oil* | 72.7 | 68.0 | 64.0 | 60.0 | 56.0 | 52.5 |
| Aerosil | 18.2 | 17.0 | 16.0 | 15.0 | 14.0 | 17.5 |
| Stearic acid | 9.1 | 15.0 | 20.0 | 25.0 | 30.0 | 30.0 |
| Total | 100 | 100 | 100 | 100 | 100 | 100 |

*the ratio of EPA:DHA is 2:1

### EXAMPLE 9

The microencapsulation of omega 3 oil compositions in Table 9 below was prepared according to the following dry microencapsulation procedure: the Aerosil and Stearic acid were mixed together by mechanical stirrer at room temperature to obtain a homogenized blend. The powder blend was heated to 70° C.The omega 3 oil was added and mixed with the powder to obtain an omega 3 granule.

TABLE 9

| | Formulation No. | | | | | |
|---|---|---|---|---|---|---|
| | 6-1 | 6-2 | 6-3 | 6-4 | 6-5 | 6-6 |
| Ingredients | (%) w/w | | | | | |
| Omega 3 oil* | 72.7 | 68.0 | 64.0 | 60.0 | 56.0 | 52.5 |
| Aerosil | 18.2 | 17.0 | 16.0 | 15.0 | 14.0 | 17.5 |
| Stearic acid | 9.1 | 15.0 | 20.0 | 25.0 | 30.0 | 30.0 |
| Total | 100 | 100 | 100 | 100 | 100 | 100 |

*the ratio of EPA:DHA is 2:1

### EXAMPLE 10

The microencapsulation of omega 3 oil compositions in Table 10 below was prepared according to the following dry microencapsulation procedure: the Aerosil and the omega 3 oil were mixed together by mechanical stirrer at room temperature to obtain a homogenized blend. Stearic acid powder was added to the blend during the mixing process and heating to 70° C. The granule remained at room temperature for 1-24 hours.

TABLE 10

Formulation No.

| | | | |
|---|---|---|---|
| 7-1 | 7-2 | 7-3 | 7-4 |

| | |
|---|---|
| Ingredients | (%) w/w |

| | | | | |
|---|---|---|---|---|
| Omega 3 oil* | 68.0 | 64.0 | 60.0 | 56.0 |
| Aerosil | 17.0 | 16.0 | 15.0 | 14.0 |
| Stearic acid | 15.0 | 20.0 | 25.0 | 30.0 |
| Total | 100 | 100 | 100 | 100 |

*the ratio of EPA:DHA is 2:1

### EXAMPLE 11

The microencapsulation of omega 3 oil in Table 11 below was prepared according to the following extrusion procedure: Aerosil and starch 1500 were mixed together by mechanical stirrer at room temperature to obtain a homogenized blend. Stearic acid powder was added to the blend during the mixing process. The omega 3 oil was added to the blend during the mixing process and heating to 70° C. to obtain a paste. The paste was converted to the pellets by Cold Extrusion-Spheronization.

TABLE 11

| | Formulation No. |
|---|---|
| | 8-1 |
| Ingredients | (%) w/w |
| Omega 3 oil* | 74.1 |
| Starch 1500 | 7.4 |
| Aerosil | 11.1 |
| Stearic acid | 7.4 |
| Total | 100 |

*the ratio of EPA:DHA is 2:1

### EXAMPLE 12

### Microencapsulation of Omega 3 Fatty Acids Test Results

Experiment No. 1: Checking the Capacity of Oil Absorption by (Avicel/Aerosil) Mixture

Materials

Avicel PH 102, Aerosil, Omega 3 Oil

Procedure

The powders of Aerosil and Avicel with different ratios as shown in the table below were mixed. The mixture was heated to get rid of the air within, omega 3 oil was added with mixing to obtain a homogenous mixture.

Results

| | Aerosil | | Avicel | | Omega 3 | |
|---|---|---|---|---|---|---|
| | Per- | | Per- | | Per- | |
| | cent % | Mass | cent % | Mass | cent % | Mass |
| Observations | (w/w) | (gram) | (w/w) | (gram) | (w/w) | (gram) |
| Wet granulate | 2.5 | 0.05 | 47.5 | 0.95 | 50 | 1 |
| Wet granulate | 5 | 0.1 | 45 | 0.9 | 50 | 1 |
| Wet granulate | 10 | 0.2 | 40 | 0.8 | 50 | 1 |
| Wet granulate | 7.5 | 0.15 | 42.5 | 0.85 | 50 | 1 |
| Fluid mixture | 3 | 0.1 | 27 | 0.9 | 70 | 2.34 |
| Fluid mixture | 4 | 0.1 | 36 | 0.9 | 60 | 1.5 |
| Paste | 8 | 0.2 | 32 | 0.8 | 60 | 1.5 |

Experiment No. 2: Melting of Stearic Acid with the Optimal Ratio of (Avicel/Aerosil) Mixture

Procedure

Avicel and Aerosil powders were mixed with different ratios of Stearic Acid, followed by heating of the mixture to around 70 C. Omega 3 oil was added with continuous mixing to obtain a homogenous mixture.

Materials

Avicel PH 102, Stearic Acid, Aerosil, Omega 3 Oil

Results

| | Stearic Acid | | Aerosil | | Avicel | | Omega 3 | | |
|---|---|---|---|---|---|---|---|---|---|
| | Percent % | Mass | Percent % | Mass | Percent % | Mass | Percent % | Mass | |
| Observations | (w/w) | (gram) | (w/w) | (gram) | (w/w) | (gram) | (w/w) | (gram) | Sample |
| Paste | 16 | 0.8 | 4.8 | 0.24 | 19.2 | 0.96 | 60 | 3 | 1 |
| Paste | 24 | 1.2 | 3.2 | 0.16 | 12.8 | 0.64 | 60 | 3 | 2 |
| Wet granulate | 10 | 0.5 | 8 | 0.4 | 32 | 1.6 | 50 | 2.5 | 3 |
| Wet granulate | 15 | 0.75 | 7 | 0.35 | 28 | 1.4 | 50 | 2.5 | 4 |
| High | 30 | 1.5 | 4 | 0.2 | 16 | 0.8 | 50 | 2.5 | 7 |
| viscosity | | | | | | | | | |
| solution | | | | | | | | | |

Experiment No. 3 : Melting of Stearic Acid Including Addition of Ethanol Materials

Avicel PH 102, Stearic Acid, Aerosil Omega 3 Oil, Ethanol

Procedure

Stearic Acid was heated until completely melted, followed by the addition of Ethanol in order to increase the volume of Stearic Acid for better binding. The previously described Avicel/Aerosil mixture with absorbed omega 3 oil was prepared, and was added to the Stearic Acid/ethanol melt to form a melted mixture. The melted mixture was heated under vacuum to remove Ethanol.

| | Stearic Acid | | Aerosil | | Avicel | | Omega 3 | | |
|---|---|---|---|---|---|---|---|---|---|
| | Percent % | Mass | Percent % | Mass | Percent % | Mass | Percent % | Mass | |
| Observations | (w/w) | (gram) | (w/w) | (gram) | (w/w) | (gram) | (w/w) | (gram) | Sample |
| Wet granulate | 16 | 0.8 | 4.8 | 0.24 | 19.2 | 0.96 | 60 | 3 | 5 |
| Dry granulate | 24 | 1.2 | 3.2 | 0.16 | 12.8 | 0.64 | 60 | 3 | 6 |

Experiment No. 4: Finding the Capacity of Oil Absorption by Aerosil Materials

Avicel PH 102, Stearic Acid, Aerosil, Omega 3 Oil

Procedure

Omega 3 oil was added to Aerosil powder with different ratios.

Results

| | Stearic Acid | | Aerosil | | Avicel | | Omega 3 | | |
|---|---|---|---|---|---|---|---|---|---|
| | Percent % | Mass | Percent % | Mass | Percent % | Mass | Percent % | Mass | |
| Observations | (w/w) | (gram) | (w/w) | (gram) | (w/w) | (gram) | (w/w) | (gram) | Sample |
| Granulate | — | — | 20 | 0.2 | — | — | 80 | 0.8 | 8 |
| Wet granulate | — | — | 15 | 0.15 | — | — | 85 | 0.85 | 9 |
| Paste | — | — | 10 | 0.1 | — | — | 90 | 0.9 | 10 |
| Paste | — | — | 10 | 0.1 | 10 | 0.1 | 80 | 0.8 | 11 |
| Paste | 9.1 | 0.1 | 18.2 | 0.2 | — | — | 72.7 | 0.8 | 12 |
| Granulate | — | — | 20 | 0.2 | — | — | 80 | 0.8 | 13 |

Experiment No. 5: Binding the Granulate of Omega 3 with Stearic Acid Materials

Stearic Acid, Aerosil, Omega 3 Oil

Procedure

Ethanol was added to melted Stearic Acid and the melt was heated to around 70 C. Omega 3 granulate which was absorbed in Aerosil was then added. The granulate contained 80% of Omega 3 oil.

| | Stearic Acid | | Aerosil | | Omega 3 | | |
|---|---|---|---|---|---|---|---|
| | Percent % | Mass | Percent % | Mass | Percent % | Mass | |
| Observations | (w/w) | (gram) | (w/w) | (gram) | (w/w) | (gram) | Sample |
| Soft granulate | 15 | 0.45 | 17 | 0.51 | 68 | 2.04 | 14 |
| Soft granulate | 20 | 0.6 | 16 | 0.48 | 64 | 1.92 | 15 |
| Soft granulate | 25 | 0.75 | 15 | 0.45 | 60 | 1.8 | 16 |
| Almost dry | 30 | 0.9 | 14 | 0.42 | 56 | 1.68 | 17 |
| granulate | | | | | | | |
| Drier | 30 | 0.9 | 17.5 | 0.525 | 52.5 | 1.575 | 22 |
| granulate | | | | | | | |

Experiment No. 6: Absorption of Omega 3 Oil Using Aerosil Powder and Binding with Stearic Acid

Materials

Stearic Acid, Aerosil, Omega 3 Oil

Procedure

The powders of Stearic Acid and Aerosil were heated together (around 70 C), and then the oil of Omega 3 was added during continuous mixing.

Results

| | Stearic Acid | | Aerosil | | Omega 3 | | |
|---|---|---|---|---|---|---|---|
| | Percent % | Mass | Percent % | Mass | Percent % | Mass | |
| Observations | (w/w) | (gram) | (w/w) | (gram) | (w/w) | (gram) | Sample |
| Dry granulate | 15 | 0.45 | 17 | 0.51 | 68 | 2.04 | 18 |
| Dry granulate | 20 | 0.6 | 16 | 0.48 | 64 | 1.92 | 19 |
| Dry granulate | 25 | 0.75 | 15 | 0.45 | 60 | 1.8 | 20 |
| Dry granulate | 30 | 0.9 | 14 | 0.42 | 56 | 1.68 | 21 |
| Drier | 30 | 0.9 | 17.5 | 0.525 | 52.5 | 1.575 | 23 |
| granulate | | | | | | | |

Experiment No. 7: Binding the Granulate of Omega 3 (Oil+Aerosil) with Stearic Acid

Materials

Stearic Acid, Aerosil, Omega 3 Oil

Procedure

Omega 3 oil was mixed with Aerosil powder to obtain a homogenous and absorbed mixture. Stearic Acid powder was dispersed on Omega 3 granulate, with heating to around 70 C during mixing.

Results

| | Stearic Acid | | Aerosil | | Omega 3 | | |
|---|---|---|---|---|---|---|---|
| | Percent % | Mass | Percent % | Mass | Percent % | Mass | |
| Observations | (w/w) | (gram) | (w/w) | (gram) | (w/w) | (gram) | Sample |
| Dry granulate | 15 | 0.45 | 17 | 0.51 | 68 | 2.04 | 24 |
| Dry granulate | 20 | 0.6 | 16 | 0.48 | 64 | 1.92 | 25 |
| Dry granulate | 25 | 0.75 | 15 | 0.45 | 60 | 1.8 | 26 |
| Dry granulate | 30 | 0.9 | 14 | 0.42 | 56 | 1.68 | 27 |

Experiment No. 8: Extrusion of Sample 24

Materials

Stearic Acid, Aerosil, Canola Oil

Procedure

The formulation was prepared as previously described, and then extruded with a manual extruder.

| | Stearic Acid | | Aerosil | | Oil | | |
|---|---|---|---|---|---|---|---|
| | Percent % | Mass | Percent % | Mass | Percent % | Mass | |
| Observations | (w/w) | (gram) | (w/w) | (gram) | (w/w) | (gram) | Sample |
| Soft product | 15 | 7.5 | 17 | 8.5 | 68 | 34 | 24 |
| Soft product | 15 | 30 | 17 | 34 | 68 | 136 | 24 |

Experiment No. 9: Extrusion of Formula Which is Prepared by Adding Starch 1500

Materials

Stearic Acid, Starch 1500, Aerosil, Canola Oil

Procedure

A mixture of Aerosil and Starch 1500 was prepared, with omega 3 oil added to the mixture with mixing. Stearic Acid was dispersed on the mixture and the mixture was heated to around 70 C. The mixture was then extruded.

| | Stearic Acid | | Starch 1500 | | Aerosil | | Oil | |
|---|---|---|---|---|---|---|---|---|
| | Percent % | Mass | Percent % | Mass | Percent % | Mass | Percent % | Mass |
| Observations | (w/w) | (gram) | (w/w) | (gram) | (w/w) | (gram) | (w/w) | (gram) |
| Soft product | 10 | 13.6 | 10 | 13.6 | 15 | 20.4 | 88.4 | 136 |

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A composition comprising omega 3 oil and one or more microencapsulation materials, wherein said one or more microencapsulation materials microencapsulates said omega 3 oil, and wherein said one or more microencapsulation materials is selected from the group consisting of: starch, microcrystalline cellulose, stearic acid and fumed silica.

2. The composition of claim 1, wherein said one or more microencapsulation materials are present in a combination selected from the group consisting of: fumed silica; microcrystalline cellulose and fumed silica; microcrystalline cellulose, stearic acid and fumed silica; fumed silica and stearic acid; and fumed silica, stearic acid and starch.

3. A composition comprising:
a core comprising the composition of claim 2;
a fatty coating layer comprising least one hydrophobic solid fat or fatty acid having a melting point lower than 70° C. and higher than 25° C.;
an intermediate coating layer positioned on said fatty coating layer; and
at least one barrier coating layer comprising a polymer having oxygen transmission rate of less than 1000 cc/m²/24 hr measured at standard test conditions and a water vapor transmission rate of less than 400 g/m²/day positioned on said intermediate layer.

4. The composition of claim 3, wherein said intermediate layer comprises a polymer having an aqueous solution of 0.1% that features a surface tension lower than 60 mN/m when measured at 25° C.

5. The composition of claim 3, wherein said intermediate layer comprises a water soluble polymer.

6. The composition of claim 3, wherein said intermediate layer comprises a polymer selected from the group including hydroxypropylethylcellulose (HPEC), hydroxypropylcellulose (HPC), methylcellulose, ethylcellulose, pH-sensitive polymers, enteric polymers and/or a combination or combinations thereof.

7. The composition of claim 3, further comprising an enteric polymer.

8. The composition of claim 7, wherein said enteric polymer comprises one or more of phthalate derivatives such as acid phthalate of carbohydrates, amylose acetate phthalate, cellulose acetate phthalate (CAP), other cellulose ester phthalates, cellulose ether phthalates, hydroxypropylcellulose phthalate (HPCP), hydroxypropylethylcellulose phthalate (HPECP), hydroxyproplymethylcellulose phthalate (HPMCP), hydroxyproplymethylcellulose acetate succinate (HPMCAS), methylcellulose phthalate (MCP), polyvinyl acetate phthalate (PVAcP), polyvinyl acetate hydrogen phthalate, sodium CAP, starch acid phthalate, cellulose acetate trimellitate (CAT), styrene-maleic acid dibutyl phthalate copolymer, styrene-maleic acid/polyvinylacetate phthalate copolymer, styrene and maleic acid copolymers, polyacrylic acid derivatives such as acrylic acid and acrylic ester copolymers, polymethacrylic acid and esters thereof, polyacrylic and methacrylic acid copolymers, and vinyl acetate and crotonic acid copolymers; shellac, phthalate derivatives, CAT, HPMCAS, polyacrylic acid derivatives, particularly copolymers comprising acrylic acid and at least one acrylic acid ester, Eudragit™ S (poly(methacrylic acid, methyl methacrylate)1:2); Eudragit L100™ (poly(methacrylic acid, methyl methacrylate)1:1); Eudragit L3OD™, (poly(methacrylic acid, ethyl acrylate)1:1); and (Eudragit L100-55) (poly(methacrylic acid, ethyl acrylate)1:1) (Eudragit™ L is an anionic polymer synthesized from methacrylic acid and methacrylic acid methyl ester), polymethyl methacrylate blended with acrylic acid and acrylic ester copolymers, alginic acid and alginates, ammonia alginate, sodium, potassium, magnesium or calcium alginate, vinyl acetate copolymers, polyvinyl acetate 30D (30% dispersion in water), a poly(dimethylaminoethylacrylate) “Eudragit E™, a copolymer of methylmethacrylate and ethylacrylate with small portion of trimethylammonioethyl methacrylate chloride (Eudragit RL, Eudragit RS), a copolymer of methylmethacrylate and ethylacrylate (Eudragit NE 30D), Zein, shellac, gums, poloxamer, polysaccharides.

9. The composition of claim 3, wherein said melting point is lower than 65° C. and higher than 30° C. or alternatively wherein said melting point is lower than 60° C. and higher than 35° C.

10. The composition of claim 3, wherein said barrier coating layer comprises one or more of Na-carboxy methyl cellulose (CMC), gelatin or starch, or a combination thereof.

11. The composition of claim 3, wherein said fatty coating layer comprises one or more of fats, fatty acids, fatty acid esters, fatty acid triesters, salts of fatty acids, fatty alcohols, phospholipids, solid lipids, waxes, lauric acid, stearic acid, alkenes, waxes, alcohol esters of fatty acids, long chain alcohols and glucoles, and combinations thereof.

12. The composition of claim 11, wherein said salt of fatty acids comprises one or more of aluminum, sodium, potassium and magnesium salts of fatty acids.

13. The composition of claim 12, wherein said fatty coating layer comprises one or more of paraffin wax composed of a chain of alkenes, normal paraffins of type CₙH₂ₙ₊₂; natural waxes, synthetic waxes, hydrogenated vegetable oil, hydrogenated castor oil; fatty acids, such as lauric acid, myristic acid, palmitic acid, palmitate, palmitoleate, hydroxypalmitate, stearic acid, arachidic acid, oleic acid, stearic acid, sodium stearat, calcium stearate, magnesium stearate, hydroxyoctacosanyl hydroxystearate, oleate esters of long-chain, esters of fatty acids, fatty alcohols, esterified fatty diols, hydroxylated fatty acid, hydrogenated fatty acid (saturated or partially saturated fatty acids), partially hydrogenated soybean, partially hydrogenated cottonseed oil, aliphatic alcohols, phospholipids, lecithin, phosphathydil cholin, triesters of fatty acids, coconut oil, hydrogenated coconut oil, cacao butter; palm oil; fatty acid eutectics; mono and diglycerides, poloxamers, block-co-polymers of polyethylene glycol and polyesters, and a combination thereof.

14. The composition of claim 13, wherein said wax comprises one or more of beeswax, carnauba wax, japan wax, bone wax, paraffin wax, chinese wax, lanolin (wool wax), shellac wax, spermaceti, bayberry wax, candelilla wax, castor wax, esparto wax, jojoba oil, ouricury wax, rice bran wax, soy wax, ceresin waxes, montan wax, ozocerite, peat waxes, microcrystalline wax, petroleum jelly, polyethylene waxes, Fischer-Tropsch waxes, chemically modified waxes, substituted amide waxes; polymerized α-olefins, or a combination thereof.

15. The composition of claim 3, wherein said solid fat or fatty acid is at least one of lauric acid, hydrogenated coconut oil, cacao butter, stearic acid, or a combination thereof.

16. The composition of claim 3, wherein said composition is adapted for admixing with a food product.

17. The composition of claim 3, further comprising a stabilizer, selected from the group consisting of dipotassium edetate, disodium edetate, edetate calcium disodium, edetic acid, fumaric acid, malic acid, maltol, sodium edetate, trisodium edetate.

18. The composition of claim 3, further comprising an oxygen scavenger selected from the group including L-cysteine base or hydrochloride, vitamin E, tocopherol or polyphenols.

19. The composition of claim 3, further comprising a surfactant in any of the coating layers, with the proviso that the surfactant is not present in the core or alternatively, if the surfactant is in the core, with the proviso that the surfactant is not an emulsion.

20. A method of producing a stabilized, multi-layered particle containing omega 3 according to claim 3, comprising:
preparing a core from omega 3 according to one of wet granulation, dry microencapsulation or extrusion;
coating the core with a first coating layer to obtain a water sealed coated particle, the first coating layer comprising a hydrophobic solid fat or fatty acid, the first coating layer preventing penetration of water into said core coating said water sealed coated particle with an intermediate coating layer that adjusts interfacial tension to obtain a water sealed coated particle having an adjusted surface tension; and
coating said water sealed coated particle having an adjusted surface tension with a barrier coating layer that reduces transmission of oxygen and humidity into the core granule to obtain a multi-layered particle containing omega 3.
